(19) United States
(12) Patent Application Publication
(10) Pub. No.: US 2023/0333020 A1
(43) Pub. Date: Oct. 19, 2023

(54) A DIAGNOSTIC DEVICE SUITABLE FOR DETECTION OF PATHOGENS, AND DETECTION METHODS USING SUCH A DEVICE

(71) Applicant: Oxford Nanoimaging Limited, Oxford (GB)

(72) Inventors: Bo Jing, Oxford (GB); Liyana Valiya Peedikakkal, (US); Matthias Steiner, (US)

(73) Assignee: Oxford Nanoimaging Limited, Oxford (GB)

(21) Appl. No.: 17/927,352

(22) PCT Filed: May 28, 2021
(86) PCT No.: PCT/EP2021/064400

§ 371 Date: Nov. 22, 2022

(30) Foreign Application Priority Data
May 29, 2020 (GB) 2008115.4

(51) Int. Cl. G01N 21/64; B01L 3/00

(52) U.S. Cl. CPC G01N 21/6486; B01L 3/502761; G01N 21/6458; G01N 21/6428; B01L 2200/0652; G01N 2021/6419; B01L 2300/0681; G01N 2021/6421; G01N 2021/6439; B01L 2300/021; B01L 2300/0867; B01L 2400/0622; G01N 2021/6467; G01N 2021/6484

(57) ABSTRACT

A detection system suitable for detecting pathogens present in a sample is presented. The detection system includes: a microfluidic channel configured to receive a sample solution containing a target biochemical component and configured to support a flow of the sample solution; an imaging lens; an excitation light source configured to emit an excitation light into a focal volume of the imaging lens; and a detector. The microfluidic channel comprises an observation section where the flow is aligned with respect to a central axis of the imaging lens such that the focal volume is within the observation section and the target biochemical component moves through a focal plane of the imaging lens during a movement along the observation section. The detector is configured to detect a light signal emitted by the target biochemical component on excitation with the excitation light.

### TECHNICAL FIELD

This specification relates to biochemical detection and diagnosis, in particular to apparatus and methods for rapidly identifying pathogens in a sample, such as a bodily fluid.

### BACKGROUND

Conventional diagnostic tests for viruses, such as SARS-CoV-2, the causative agent of COVID-19, usually have poor scalability.

Although various forms of polymerase chain reaction (PCR) are accepted as reliable methods, these tests require enzymes that are expensive to produce, time for amplification, a relatively clean input sample after RNA extraction. In addition, the methods require specialist equipment and protocols that prevent their use in rapid “on the spot” testing applications.

Tests that are sensitive to either SARS-CoV-2 proteins such as spike protein or antibodies against SARS-CoV-2 proteins may suffer from long run time, sensitivity and specificity issues similar to existing tests for proteins. Any test that uses protein to detect other proteins is inherently more expensive and harder to scale compared to a purely nucleic acid based tests due to the ease of synthesising nucleic acids chemically compared to the difficulty of manufacturing proteins from living organisms.

The COVID-19 pandemic has highlighted the unmet need for relatively inexpensive and compact pathogen detection apparatus that is able to reliably and rapidly detect pathogens in samples, and permit use by non-specialist operatives.

### SUMMARY OF THE INVENTION

According to an aspect of the present invention, there is provided a detection system, which includes a microfluidic channel configured to receive a sample solution containing a target biochemical component and configured to support a flow of the sample solution; an imaging lens; an excitation light source configured to emit an excitation light into a focal volume of the imaging lens; and detection apparatus. The microfluidic channel comprises an observation section where the flow is aligned with respect to a central axis of the imaging lens such that the focal volume is within the observation section and the target biochemical component moves through a focal plane of the imaging lens during a movement along the observation section. The detection apparatus comprises a detector configured to detect a light signal emitted by the target biochemical component on excitation with the excitation light.

The microfluidic channel may be configured to support flow parallel to the central axis such that an emission from the target biochemical component is received around a fixed point on the detector during the movement through the focal volume. This may be achieved by having the microfluidic channel extend along the central axis of the imaging lens.

Alternatively, the microfluidic channel may be configured to provide flow at an angle with respect to the central axis such that an emission from the target biochemical component is received within an elongated area on the detector of the detection apparatus during the movement through the focal volume. This may be achieved by having the microfluidic channel extend along the central axis of the imaging lens at an angle. The angle may be a relatively shallow angle. For example, the angle may be no more than 5°, no more than 10°, no more than 20°, no more than 25° or no more than 30°, or no more than 45°.

Preferably, the excitation light source is configured to provide excitation light in a wide-field illumination mode, for example through wide-field epifluorescence microscopy (in which the excitation light passes through the imaging lens) or light sheet fluorescence microscopy (in which the excitation light is provided independently of the imaging lens).

Preferably, the excitation light source is configured to provide excitation light comprising one or more light sheets directed across the microfluidic channel. Advantageously, use of light sheet illumination helps to reduce background signals and photobleaching of fluorescent molecules. This may be achieved, for example, by the provision of a cylindrical lens in the beampath of the excitation light.

More preferably, the excitation light source is configured to provide excitation light comprising one or more light sheets laterally at and parallel to the focal plane of the imaging lens (about or exactly 90° to the central axis). Advantageously, illuminating with a light sheet laterally at and parallel to the focal plane of the imaging lens can ensure that the power density of illumination is relatively symmetrical about the central axis. In contrast, if a light sheet is directed at an angle relative to the focal plane, then this can cause/contribute to variation of the power density across the focal volume of the lens, which can thereby cause unwanted variation in the signal detected from the target biochemical component depending on its position within the focal volume.

Optionally, the microfluidic channel is configured to support flow parallel to the central axis and the excitation light source is configured to provide excitation light comprising one or more light sheets directed across the microfluidic channel, preferably wherein the one or more light sheets are illuminated laterally at and parallel to the focal plane of the imaging lens (perpendicular to the central axis).

In instances where the excitation light source is configured to provide excitation light comprising one or more light sheets, the excitation light source is preferably configured such that the thickness of the one or more light sheets (measured parallel to the central axis of the imaging lens) as it/they intercept the focal volume is comparable to the thickness of the focal volume of the imaging lens. For example, the excitation light source may be configured such that thickness of the one or more light sheets is less than or equal to the focal volume. Advantageously, this helps to limit background signals and limit the possibility of photobleaching in fluorescence-based methods. In practice, the thickness of the one or more light sheets at the point at which it/they intercept the central axis of the imaging lens may be, for example, 20 μm or less, 15 μm or less, 10 μm or less, or 5 μm or less (as measured parallel to the central axis of the imaging lens).

The microfluidic channel may have a diameter of, for example, less than 600 μm, less than 500 μm, or less than 400 μm in the region of the observation section. For example, the microfluidic channel may have a diameter of 100 μm to 600 μm, 100 μm to 500 μm, or 100 μm to 400 μm in the region of the observations section. Preferably, the microfluidic channel has a diameter in the region of the observation section which is equal to or less than the width of the focal volume of the imaging lens.

The excitation light source may be configured so that the width of the excitation light in the observation section is comparable to the diameter of the microfluidic channel. For example, 80% or more, 90% or more, or 95% or more of the illumination power (beam profile) may be focussed within the microfluidic channel.

Optionally, the detector is or comprises a camera. In such implementations, the imaging lens and camera preferably allow imaging of the whole cross-section of the microfluidic channel (that is, the cross-section across the width of the microfluidic channel). In such instances the excitation light source is preferably configured such that the excitation light illuminates the whole of said cross-section of the microfluidic channel. Advantageously, in such instances it may be possible to analyse a sample in its entirety. This can be important when detecting pathogens in bodily fluids, where the concentration of pathogens may be relatively low.

Optionally, the excitation light source is configured to provide excitation light comprising a plurality of wavelengths and the detection apparatus is configured to distinguish respective spectral channels of the light signals generated on excitation with the plurality of wavelengths of the excitation light source.

Preferably, the excitation light source is configured to provide excitation light comprising one or more light sheets comprising a plurality of wavelengths. In particular, the excitation light source may be configured to provide excitation light comprising multiple light sheets of different wavelengths. In such instances, the light sheets for different wavelengths may be aligned in the z-axis. The multiple light sheets 20 of different wavelengths may overlap in at least 70% of the focal volume within the microfluidic channel, at least 80% of the focal volume within the microfluidic channel, or at least 90% of the focal volume within the microfluidic channel.

The excitation light source may be configured such that the combined thickness of the volume illuminated by the multiple light sheets of different wavelengths is, for example, 40 μm or less, 30 μm or less, 20 μm or less, 15 μm or less, 10 μm or less, or 5 μm or less.

The excitation light source may comprise one or more (optical) fibre-coupled light sources, such as one or more fibre-coupled lasers. Advantageously, the use of fibre-coupled light sources can permit a relatively compact construction of the diagnostic device, whilst permitting easy manipulation and alignment of the excitation light path. In implementations configured to provide multiple light sheets of different wavelengths, there may be multiple fibre-coupled light sources each configured to provide one or a subset of the different wavelengths. Preferably, the excitation light source may comprise multiple fibre-coupled light sources which directly illuminate the focal volume (without a combiner to combine the output of the fibre-coupled light sources before illumination). Advantageously, such an approach avoids the complication and expense of trying to couple the output from multiple optical fibres together. In other words, the excitation light source may omit a fibre-optic combiner.

The multiple fibre-coupled light sources are preferably aligned such that their excitation light is directed in the same plane, preferably aligned such that their excitation light is directed in the focal plane of the imaging lens.

In such implementations, the fibre-coupled light sources may be configured so as to emit their excitation light at an angle relative to one another. This may be achieved by distributing the output of the fibre-coupled light sources around the microfluidic channel, for example, by spacing the fibre optic cables around the microfluidic channel at an angle relative to one another, e.g. with two fibre-coupled light sources emitting their light in the same plane at 90° to one another. For example, the fibre-coupled light sources may be aligned such that their excitation light is directed in the focal plane of the imaging lens, and distributed so that there is an angle between the excitation light of different fibre-coupled light sources.

Alternatively, the fibre-coupled light sources may be configured so as to emit their excitation light parallel to one another. In such implementations, it is preferable for the fibre-coupled light sources to be configured so as to emit their excitation in the same direction. To achieve this, the (emission) ends of multiple fibre-coupled light sources may be arranged side-by-side in an array, positioned on one side of the microfluidic channel. Such an array may be a horizontal array (as judged relative to the central axis); that is, with the array extending in the x and/or y direction, instead of being “stacked” in the z direction along the central axis. Advantageously, arranging the fibre-coupled light sources in such a manner can permit a more compact design for the detection system than spacing the ends of the fibre-coupled light sources around the microfluidic channel. In particular, by placing the (emission) ends of the fibre-coupled light sources side-by-side it is relatively straightforward to use a shared lens (e.g. cylindrical lens) to form the excitation light from the fibre-coupled light sources into light sheets which overlap with one another within the focal volume, in a way which is not possible when the ends of the fibre-coupled light sources are angled relative to one another. In such an implementation, the fibre-coupled light sources may be configured in a side-by-side array in the focal plane of the imaging lens.

Particularly preferred are implementations in which the ends of multiple fibre-coupled light sources are arranged side-by-side in an array with a shared lens (e.g. cylindrical lens) on one side of the microfluidic channel.

Preferably, the microfluidic channel is configured to provide flow parallel to the central axis and the excitation light source is configured to provide excitation light comprising one or more light sheets comprising different wavelengths, wherein the one or more light sheets are directed across the microfluidic channel, most preferably wherein the one or more light sheets are illuminated laterally at and parallel to the focal plane of the imaging lens (perpendicular to the central axis).

More preferably, the microfluidic channel is configured to provide flow parallel to the central axis and the excitation light source comprises multiple fibre-coupled light sources configured to provide excitation light at different wavelengths, wherein the emission ends of the fibre-coupled light sources are arranged side-by-side in an array on one side of the microfluidic channel, and wherein a shared cylindrical lens is positioned in front of the ends of the fibre-coupled light sources to shape the excitation light from the multiple fibre-coupled light sources into light sheets during use. Such light sheets are preferably focussed at the centre of the focal volume of the imaging lens.

The detection apparatus may comprise one or more optical filters (e.g. a dichroic filter, polychroic filter, longpass filter, bandpass filter, or combinations thereof) to separate light signals into two or more colour channels. Such optical filters may be referred to as “light signal splitting filters”. The different colour channels may be detected on separate detectors and/or detected on separate areas of a single detector. Additionally, or alternatively, the detection apparatus may comprise a dispersive element (such as a prism or grating) to separate (disperse) light signals into different wavelengths such that different wavelengths illuminate different parts of a detector. Implementations comprising said one or more light signal splitting filters and/or dispersive element(s) are used, in particular, when the excitation light source is configured to provide excitation light comprising a plurality of wavelengths.

In implementations comprising both a light signal splitting filter and a dispersive element, the dispersive element may be in front of the light signal splitting filter, or the dispersive element may be behind the light signal splitting filter (“in front” denoting relatively closer proximity to the imaging lens). In instances where the dispersive element is positioned behind the light signal splitting filter, the same dispersive element may be used to separate light signals in more than one colour channel (optionally all colour channels). For example, a single prism may span two or more (possibly all) colour channels.

The light signals are preferably re-collimated after being dispersed by a dispersive element. Re-collimation may be achieved by the dispersive element itself. For example, the dispersive element may take the form of a compound prism, which spatially disperses the emission and the re-collimates the emission.

In preferred implementations the dispersive element is a prism. The prism is preferably a compound prism, such as a doublet compound prism. A doublet compound prism may take the form of two wedge prisms fused/cemented along a shared facet such that their apex angles face away from one another. Advantageously, prisms can provide a compact structure for achieving dispersion with a combination of lower photon loss and lower (or no) deviation of emission compared to gratings.

In an especially preferred implementation, the microfluidic channel is configured to support flow parallel to the central axis of the imaging lens, the excitation light source is configured to provide excitation light comprising one or more light sheets comprising different wavelengths illuminated laterally at and parallel to the focal plane of the imaging lens (perpendicular to the central axis), the detection apparatus comprises one or more optical filters (e.g. a dichroic filter, longpass filter, bandpass filter, or combinations thereof) to separate light signals into two or more colour channels, and the detection apparatus preferably further comprises a dispersive element (such as a prism or grating) to separate light signals into different wavelengths such that different wavelengths illuminate different parts of the detector(s). In such an implementation, the excitation light source preferably comprises multiple fibre-coupled light sources, in the manner set out above.

The detection system may be configured to detect the target biochemical component through fluorescence, scattering, or a combination of fluorescence and scattering. For example, the detection system may be configured to measure the size of the target biochemical component by scattering and/or the composition, structure and organisation of the target biochemical component by fluorescence.

Preferably, the detection system is configured to detect the target biochemical component through fluorescence. In such instances, the detection system generally includes one or more excitation light filters for attenuating/blocking transmission of wavelengths corresponding to the excitation light from being detected by the detection apparatus. This allows Stokes-shifted fluorescence emission to be separated from scattered excitation light. The excitation light filters may be, for example, bandpass or longpass filters. The detection apparatus may include, for example, one or more light signal splitting filters to separate light signals into two or more colour channels, and one or more excitation light filters to remove excitation light from the two or more colour channels.

Optionally, the detection system is configured to detect the target biochemical component through both fluorescence and scattering. For example, the detection system may be configured to detect the target biochemical component through both fluorescence microscopy and darkfield microscopy. The fluorescence signals and scattering signals may be detected separately—for example, the detection system may incorporate separate sets of excitation sources and detection apparatus for measuring fluorescence and scattering. However, preferably, the detection system is configured to measure fluorescence and scattering signals using the same set of excitation sources and detection apparatus. Ideally, the detection system is configured to measure fluorescence and scattering signals from individual target biochemical components simultaneously as they transit through the observation section. To carry out such an implementation the detection apparatus may comprise one or more light signal splitting filters to separate light signals into two or more colour channels, wherein at least one of the colour channels is a fluorescence detection channel and at least one of the colour channels is a scattering detection channel, wherein the detection apparatus incorporates an excitation light filter configured to attenuate excitation light from impinging on the detector in the fluorescence detection channel, and wherein the detection apparatus is configured to allow scattered excitation light to reach the detector in the scattering detection channel. In such implementations, the excitation light source preferably comprises a plurality of wavelengths, wherein a subset (one or more) of the wavelengths are used for fluorescence excitation and a subset (one or more) are used for scattering. For example, the excitation light source may comprise two or more fibre-coupled lasers for fluorescence excitation and one fibre-coupled laser for scattering. The choice of which wavelength(s) are used for fluorescence and which wavelength(s) are used for scattering will be dictated by the particular protocol, and in particular the fluorescent labels chosen. This choice will dictate the arrangement of the excitation light filter(s).

Optionally, the excitation light source is configured to emit the excitation light in pulses such that the target biochemical component is illuminated for a predetermined period during the movement through the focal volume. Alternatively, the excitation light source is configured to emit the excitation light continuously.

Suitably, the detection system will include a pressure source to cause flow of sample through the microfluidic channel. The pressure may be supplied through any known means, such as by a gas (for example delivered from a gas supply) or a pump/plunger (applying either positive or negative pressure).

Optionally, the detection system includes a temperature control system, to control temperature of the sample. For example, the detection system may include a temperature control system to maintain the target biochemical component at a physiologically relevant temperature, such as 37° C. Advantageously, this can allow the measurements to provide more inciteful physiologically relevant data. The temperature control system may include, for example, a resistive heater or a thermoelectric (Peltier) heater.

Suitably, the microfluidic channel is provided as part of a microfluidic chip.

The microfluidic channel may be provided as part of a testing module on a microfluidic chip. The testing module may have a sample inlet port and (optionally) sample outlet port in fluid communication with said observation section of the microfluidic channel. The detection system optionally includes multiple testing modules. For example, the same microfluidic chip may incorporate several such testing modules, optionally multiple identical testing modules. In implementations incorporating multiple testing modules, the testing modules are preferably movable so that they can be examined in turn. This can allow, for example, one testing module to be cleaned ahead of reuse whilst the other is being examined, helping to improve the rate at which multiple samples can be processed. Preferably, movement of the testing modules in this way is achieved by an actuation mechanism, for example in the form of a motor.

In a particularly preferred implementation, the microfluidic chip includes two testing modules which have the observation sections in relatively close proximity, allowing switching between the testing modules with relatively modest movement of the microfluidic chip. For example, the microfluidic chip may have two mirror image testing modules with observation sections towards the centre of the mirror image, allowing switching between the testing modules in a small (e.g. lateral) movement. Larger microfluidic chips may be constructed from multiple sets of such “paried” mirror image testing modules.

Optionally, there is provided a system including the detection system aforementioned; and a purifying unit configured to select the target biochemical component in the sample solution based on a size of the target biochemical component. The microfluidic channel is configured to receive an output of the purifying unit. Optionally, the purifying unit comprises a size exclusion column, SEC.

Optionally, the purifying unit comprises a device for high performance liquid chromatography, HPLC.

Optionally, the system further includes a plurality of the detection systems aforementioned. The output of the device for high performance liquid chromatography is configured to receive a plurality of the sample solution with a time delay between each of the plurality of the sample solution and to distribute the purified output correspondingly in time into the plurality of the detection unit.

According to an aspect of the present invention, there is provided a method of detecting a target biochemical component. The method includes: preparing a sample solution containing the target biochemical component such that the target biochemical component is labelled with one or more optical markers; sending the sample solution into a microfluidic channel configured to support a flow of the sample solution; providing an excitation light into a focal volume of an imaging lens; detecting the target biochemical component using detection apparatus configured to detect a light signal emitted by the one or more optical markers on excitation with the excitation light. The microfluidic channel comprises an observation section where the flow is aligned with respect to a central axis of the imaging lens such that the focal volume is within the observation section and the target biochemical component moves through a focal plane of the imaging lens during a movement along the observation section.

Optionally, the optical markers are fluorescent markers, and the light signals are fluorescence emission.

The method may use a detection system incorporating any of the optional and preferred features discussed above in relation to the detection system.

For example, in a preferred implementation providing an excitation light comprises providing excitation light comprising different wavelengths.

In another preferred implementation providing an excitation light comprises providing one or more light sheets into the focal volume of the imaging lens, preferably across the microfluidic channel. The one or more light sheets are preferably illuminated laterally at and parallel to the focal plane of the imaging lens (perpendicular to the central axis of the imaging lens). Preferably, the one or more light sheets comprise different wavelengths. Each of the different wavelengths may be used to excite spectrally distinct optical markers, such as different fluorescent markers. In a particularly preferred implementation, light sheets are provided by multiple fibre-coupled light sources (e.g. fibre-coupled lasers), each (or a subset) of the fibre-coupled light sources providing a different wavelength, preferably wherein the ends of the fibre-coupled light sources are arranged so as to emit parallel beams which impinge on a shared lens (e.g. cylindrical lens) which focuses the light sheets into the focal volume (for example, by providing the ends of the fibre-coupled light sources side-by-side). The light sheet characteristics in terms of thickness and overlap are as described above in relation to the detection system.

The method may involve separating the light signals into two or more colour channels. The different colour channels may be detected on separate detectors and/or detected on separate areas of a single detector. Additionally, or alternatively, the detection apparatus may comprise a dispersive element (such as a prism or grating) to separate light signals into different wavelengths as described in relation to the detection system.

Suitably, the microfluidic channel is provided as part of a testing module on a microfluidic chip. Preferably, the method involves imaging a first testing module (e.g. until analysis of a sample is complete or a certain threshold criterion is met, such as detection of a sufficient quantity of target pathogens), whilst simultaneously cleaning a second testing module, before then switching to imaging of the second testing module and cleaning of the first testing module. The first and second testing modules may be provided on the same microfluidic chip, as mentioned above in relation to the detection system. Preferably, the first and second testing modules are provided on the same microfluidic chip, and the method involves translating the microfluidic chip in order to switch from imaging of the first testing module to imagine of the second testing module.

In a particularly preferred implementation, the method comprises:
preparing a sample solution containing the target biochemical component such that the target biochemical component is labelled with one or more fluorescent markers;
sending the sample solution into a microfluidic channel configured to support a flow of the sample solution, wherein the microfluidic channel comprises an observation section;
providing multiple excitation light sheets comprising different wavelengths into the focal volume of an imaging lens, wherein the multiple light sheets are illuminated laterally at and parallel to the focal plane of the imaging lens, and wherein the focal volume is within the observation section of the microfluidic channel and flow of the sample solution is parallel to the central axis of the imaging lens within the observation section;
detecting the target biochemical component using detection apparatus configured to detect fluorescence emission emitted by the one or more fluorescent markers on excitation with the excitation light sheets as the target biochemical component moves through a focal plane of the imaging lens during a movement along the observation section; wherein the detection apparatus comprises one or more optical filters (bandpass filters) to separate the fluorescence emission into two or more colour channels which are detected on separate detectors and/or detected on separate areas of a single detector, and optionally wherein the detection apparatus comprises a dispersive element (such as a prism or grating, preferably a prism), to separate light signals into different wavelengths before it is detected by the detector(s). The dispersive element is preferably positioned after said optical filter(s), and may be used to separate light signals in more than one colour channel. The method may involve characterising the target biochemical component based on the absolute and/or relative signal intensity in the two or more colour channels and/or the spectrum arising from dispersion by the dispersive element.

In some implementations, the method further includes: purifying the sample solution to select the target chemical component labelled with the one or more optical markers in the sample solution; sending the purified sample solution into the microfluidic channel.

In some implementations, the flow is at an angle with respect to the central axis such that an emission from the target biochemical component received within an elongated area on the detector during the movement through the focal volume. The excitation light comprises a plurality of pulses arranged to illuminate the target biochemical element at different periods of time during the movement through the focal volume. Respective pulses have different wavelengths.

In some implementations, detecting the target biochemical component further comprises evaluating a signal intensity profile. In instances where the flow is at an angle with respect to the central axis, this implementation may comprise evaluating a signal intensity profile in the elongated area on the detector. In instances where a dispersive element is used, evaluating a signal intensity profile may involve distinguishing different fluorophores based on their point spread functions.

In some implementations, the detector comprises a plurality of spectral channels for distinguishing the light signals generated on excitation of the target biochemical component. Detecting the target biochemical component further comprises evaluating the signal intensity profile in the plurality of spectral channel. In instances where the flow is at an angle with respect to the central axis, this implementation may comprise evaluating the signal intensity profile in the elongated area in the plurality of spectral channels.

Suitably, the light signal is a diffraction limited spot imaged by a camera, and determining the signal intensity profile comprises summing pixel intensities within a window around the spot, or fitting a suitable function to the diffraction limited spot (such as a 2D Gaussian function).

In some implementations, preparing the sample solution further includes: adding a buffer solution to a sample containing the target biochemical component. The buffer solution comprises a detection probe and an imaging probe. The detection probe is configured to hybridise with the target biochemical component and to hybridise with the imaging probe. The imaging probe comprises the one or more optical markers.

In some implementations, preparing the sample solution further includes adding a solution to a sample containing the target biochemical component. The solution comprises a directly labelled detection probe. The directly labelled detection probe is configured to hybridise with the target biochemical component and comprises the one or more optical markers.

Preferably, the target biochemical component is a pathogen, such as a virus. Preferably, the target biochemical component is a fluorescently-labelled pathogen, such as a fluorescently-labelled virus.

Preferably, the target biochemical component is a pathogen and the concentration of pathogen in the sample solution is chosen so that multiple pathogens are observed/observable in the focal volume simultaneously. This should stand in contrast to conventional flow cytometry techniques in which cells must be observed individually, and which are thereby more limited in throughput rate.

In implementations in which the target biochemical component is a virus, preparing the sample solution may further include: adding solution containing positively charged ions from metal salts to a sample; and adding a labelling probe comprising the one or more optical markers which are negatively charged and chelate to the positively charged ions.

### Especially Preferred Implementations

In a particularly preferred implementation, the detection apparatus comprises:
a microfluidic channel configured to receive a sample solution containing a target biochemical component;
an imaging lens;
an excitation light source configured to provide excitation light comprising one or more light sheets comprising different wavelengths illuminated laterally at and parallel to the focal plane of the imaging lens; and
detection apparatus, comprising a detector (preferably a camera);
wherein the microfluidic channel comprises an observation section where the flow is aligned with respect to a central axis of the imaging lens such that the focal volume is within the observation section and the target biochemical component moves through a focal plane of the imaging lens during a movement along the observation section,
wherein the microfluidic channel is configured to support flow parallel to the central axis such that an emission from the target biochemical component is received around a fixed point on the detector during the movement through the focal volume
wherein the detector is configured to detect a light signal emitted by the target biochemical component on excitation with the excitation light.

Preferably, the excitation light source is multiple fibre-coupled lasers configured to provide excitation light at different wavelengths (for example, a 488 nm fibre-coupled laser, a 640 nm fibre-coupled laser, and a 730 nm fibre-coupled laser), wherein the (emission) ends of the fibre-coupled lasers are arranged side-by-side in an array with a shared lens (e.g. cylindrical lens) on one side of the microfluidic channel, and are configured to direct excitation light in the focal plane of the imaging lens.

Additionally, or alternatively, the microfluidic channel is provided as part of one of several testing modules on a microfluidic chip, wherein the microfluidic chip is movable to allow switching between imaging of different testing modules.

In a particularly preferred implementation, the method is used for detecting a pathogen in a sample of bodily fluid, and comprises the steps of:
obtaining a sample of bodily fluid from a patient;
incubating the sample with one or more fluorescent markers capable of binding to a pathogen of interest;
sending the sample solution into a microfluidic channel configured to support a flow of the sample solution, wherein the microfluidic channel comprises an observation section;
providing multiple excitation light sheets comprising different wavelengths into the focal volume of an imaging lens, wherein the multiple light sheets are illuminated laterally at and parallel to the focal plane of the imaging lens, and wherein the focal volume is within the observation section of the microfluidic channel and flow of the sample solution is parallel to the central axis of the imaging lens within the observation section;
detecting fluorescence emitted by the sample as it flows through the focal plane of the imaging lens using detection apparatus; the detection apparatus comprising one or more optical filters (bandpass filters) to separate the fluorescence emission into two or more colour channels which are detected on separate detectors and/or detected on separate areas of a single detector, and optionally wherein the detection apparatus comprises a dispersive element (such as a prism or grating), preferably after said optical filter(s), to separate light signals into different wavelengths before it is detected by the detector(s);
identifying fluorescent events above a threshold in the two or more colour channels;
using the fluorescent events to identify whether pathogens are present in the sample.

Preferably, the method further involves detecting scattering from the pathogen. This detection may be achieved in the manner taught above in relation to the detection system, and may involve use of darkfield microscopy.

### BRIEF DESCRIPTION OF THE DRAWINGS

Certain embodiments of the present invention will now be described, by way of examples, with reference to the accompanying drawings, in which:

FIG. 1 is a schematic that illustrates an exemplary embodiment of a detection system according to the present invention.

FIG. 2 is a flowchart illustrating a method of detecting a target biochemical component.

FIG. 3a is a schematic that illustrates an optical barcode scheme.

FIG. 3b is a schematic for illustrating an example of optical barcode data.

FIG. 4 is a schematic that illustrates a microfluidic chip for detecting biochemical component.

FIGS. 5A and 5B are respectively top and side schematic views of an excitation light source for use in the present invention, in which the output from multiple fibre-coupled lasers is formed into a light sheet through a shared cylindrical lens.

FIG. 5C is a schematic view of a mounting block suitable for aligning the lasers in the manner shown in FIGS. 5A and 5B.

FIG. 6 is a schematic showing a doublet compound prism which spectrally disperses emission before it impinges on a camera, suitable for use in the detection apparatus of the invention.

FIG. 7A shows an of image of orange/green emission from fluorescent beads labelled with Alexa Fluor 488 and Alexa Fluor 568, with the emission spread vertically across the image using a doublet compound prism as depicted in FIG. 6.

FIG. 7B is a close-up of the detected signal from a single fluorescent bead of FIG. 7A, with the signal associated from Alexa Fluor 488 occurring below that of Alexa Fluor 568.

FIG. 7C is a plot of pixel intensity data across the dotted line of FIG. 7B, showing that the profile reflects the emission spectra of Alex Fluor 488 and Alex Fluor 568.

FIG. 8A shows a schematic view of an especially preferred implementation of the diagnostic system of the present invention, incorporating a prism.

FIG. 8B shows an alternative preferred implementation to that of FIG. 8A showing an alternative position for the prism.

FIG. 9 shows a schematic view of a preferred system for driving sample delivery to a microfluidic chip in the method of the present invention.

### DETAILED DESCRIPTION

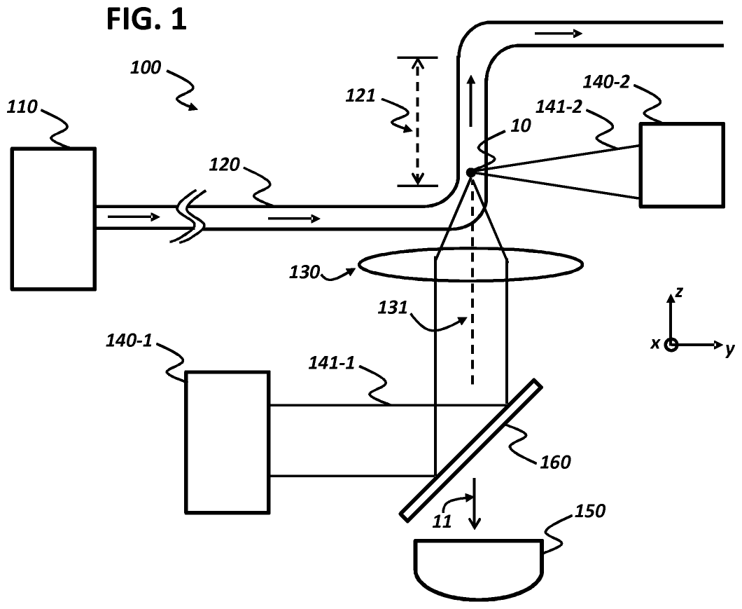

FIG. 1 is a schematic that illustrates an exemplary embodiment of a detection system.

The detection system 100 is configured to detect the presence of a target biochemical component 10 in a sample solution by optically detecting and imaging the target biochemical component 10.

The detection system 100 includes a microfluidic channel 120, an imaging lens 130, an illumination source 140-1, 140-2, a detector 150. In some implementations, the detection system 100 further includes an optical element 160. In some implementations, the detection system 100 includes a purifying unit 110.

The examples of the imaging lens 130 includes an oil immersion objective lens, an air objective lens, aspheric lens, and an achromatic lens although the imaging lens 110 is not limited to these examples.

The purifying unit 110 is configured to receive the sample solution which includes the target biochemical component 10.

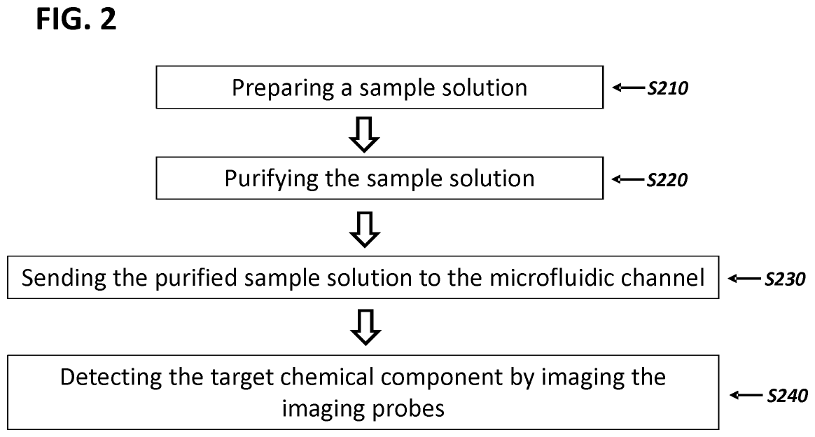

In the sample solution, the target biochemical component 10 may be labelled with an imaging probe IP or a labelling probe LP, which includes one or more optical markers such as a fluorescent dye molecule, a semiconductor quantum dot, or a nanoparticle, which enables optical imaging. Labelling can be achieved by hybridisation or any other suitable methods, which will be described in more detail in FIG. 2.

In some implementations, the target biochemical component 10 may be rendered to provide optical emission 11 on excitation by the illumination source 140-1, 140-2. For example, the target biochemical component 10 may be hybridised with a molecule labelled with fluorescent markers. For another example, the target biochemical component 10 may be hybridised with a molecule which acts as an efficient optical scatterer or an efficient optical absorber to form a complex. For another example, the target biochemical component 10 may be a fluorescent molecule or include a fluorescent marker. For another example, the target biochemical component 10 may scatter or absorb light efficiently. The preparation of the sample solution will be discussed in more detail in the method of FIG. 2.

The size of the target component is taken to be below the diffraction limit of the wavelength of the illumination from the illumination source 140-1, 140-2.

The purifying unit 110 is configured to select the target biochemical component 10 or the complex formed with the target biochemical component 10 for optical detection.

In some implementations, the purifying unit 110 may be configured to select the target biochemical component 10 or the complex formed with the target biochemical component 10 for optical detection based on the size or charge of the target biochemical component 10 or the complex.

For example, the purifying unit 110 may be a filter. A filter can be used to remove non-pathogenic material (endogenous cells) from a bodily fluid whilst permitting smaller pathogen cells (e.g. viruses) to transit the filter. To this end, the filter may have an average pore size between about 0.2 μm to about 2 μm, more preferably 0.2 μm to 1 μm, more preferably 0.2 to 0.8 μm, most preferably 0.2 μm to 0.5 μm.

In some implementations, the purifying unit 110 may be a high performance liquid chromatography (HPLC) device.

In some implementations, the purifying unit no may be a size exclusion column (SEC). In this case, the size exclusion column may be integrated in the high performance liquid chromatography device. In some implementations, the size exclusion column may be used in a centrifuge or on a vacuum line.

In some implementations, in case the purifying unit 110 comprises a vacuum driven size exclusion column (SEC) or a vacuum driven high performance liquid chromatography device (HPLC), the purifying unit 110 is configured to directly connect the output of the purifying unit 110 to the microfluidic channel 120 without the need to manually introduce the sample solution into the microfluidic channel 120.

In some implementations, the column can be mounted on the microfluidic chip containing the microfluidic channel 120 and the vacuum to drive the flow of the sample in the microfluidic channel 120 can be used to drive the sample through the purifying unit 100 and into the microfluidic channel 120.

In some implementations, the high performance liquid chromatography (HPLC) device 110 may be configured to receive multiple sample solutions with a time delay between each type of target biochemical component 10 and distribute the purified output correspondingly in time, such that each output can be correlated with different types of labels of the target biochemical component 10.

The output of the purifying unit no, the purified sample solution, is inserted into a microfluidic channel 120. A negative pressure compared to the atmosphere is exerted, for example, using a vacuum system, such that the sample solution is pulled into the microfluidic channel 120. The microfluidics channel 120 and auxiliary devices to support the microfluidics channel 120 are arranged such that flow direction can be reversed.

The microfluidic channel 120 includes a section, or an observation section 121 which is connected to the rest of the microfluidic channel 120. For example, as shown in FIG. 1, the initial part of the microfluidic channel 120 extends in the y-direction, then makes a bend in the z-direction, such that the flow of the sample solution is directed in the z-direction. However, the observation section 121 is not limited to be a bend within the microfluidic channel 120 as depicted in FIG. 1. For example, the observation section 121 may be arranged to be towards the end of microfluidic channel 120 and can be a tubing that serves as an output from the microfluidic channel 120. Any part of the microfluidics channel 120 or any part connected immediately to the microfluidics channel 120 configured to support the flow of the sample solution suitable for the optical detection as described below can serve as the observation section 121.

An excitation light 141-1, 141-2 provided by the illumination source 140-1, 140-2 is focused at a point within the section 121 of the microfluidic channel 120.

In some implementations, the excitation light 141-1 may be provided and focused by the imaging lens 130. In this case, the excitation light 141-1 may be provided as a wide-field illumination.

In some implementations, the excitation light 141-2 may be provided without going through the imaging lens 130. In this case, additional optics, although not shown in the FIG. 1, is provided to provide with the illumination source 140-2 for focusing the excitation light 141-2.

In some implementations, the excitation light 141-2 comprises a sheet of light with a thickness that corresponds to the depth of focus of the imaging lens 130. The sheet of light may be illuminated laterally at and parallel to the focal plane of the imaging lens 130, such that the focal plane of the imaging lens 130 is illuminated. This mode of illumination reduces background signals and photobleaching in case the target biochemical component 10 is labelled with fluorescent molecules. Illuminating with a light sheet also helps to achieve greater laser power density by focusing the laser light into a thin sheet the width of which matches one dimension of the field of view, e.g. 250 μm, and the thickness of which matches the depth of focus of the detection objective, e.g. 10 μm thick. The section 121 and the imaging lens 130 are aligned with respect to each other such that when the target biochemical component 10 is imaged in the field of view, the target biochemical component 10 traverses the focal volume of the imaging lens 130 along the central axis 131 or traverses the focal plane, namely from outside the focal volume to within the focal volume, again to outside the focal volume due to the flow within the section 121. As a result, the image of the biochemical component 10 appears out-of focus, in-focus, then again out-of focus as it moves along the observation section 121.

For example in FIG. 1, the section 121 extends in the z-direction and the imaging lens 130 is aligned such that the central axis 131 is in the z-direction and the central axis 131 traverses the observation section 121 in the z-direction.

In some implementations, the imaging lens 130 may be configured to provide a focusing of the illumination beam 141-1 at the focal plane within the observation section 121 and simultaneously to provide an efficient collection of the emission from within the observation section 121 near the focal plane.

The illumination source 140-1 or 140-2 may comprise one or more lasers. The illumination source 140-1 or 140-2 preferably comprises multiple lasers which each emit at different wavelengths. For example, the excitation light source may include any combination of a first laser operating below 500 nm (for example, 350 nm-500 nm), a second laser operating between 500-600 nm, a third laser operating between 600-700 nm, and a fourth laser operating above 700 nm. For example, the illumination source 140-1 and/or 140-2 may include lasers operating at 488 nm, 561 nm, 640 nm and/or 750 nm. Preferably, the illumination source incorporates lasers capable of emission at three or more wavelengths, optionally four or more wavelengths. The emission from the different wavelengths is preferably aligned so as to overlap in the focal volume within the observation section.

Preferably, the illumination source 140-1 or 140-2 comprises one or more optical fibre-coupled lasers (referred to simply as “fibre-coupled” lasers). Advantageously, using fibre-coupled lasers allows a small, highly collimated beam to be produced in a small space with minimal optics. Preferably the illumination source 140-1 or 140-2 comprises multiple fibre-coupled lasers which each emit at a different wavelength. To achieve overlap of the output from the multiple fibre-coupled lasers, the output from different fibres may be coupled into a single fibre using a fibre combiner (for example using a wavelength combiner such as Thorlabs GB19A1) before being directed at the focal volume, as taught in Sala et al., Biomedical Optics Express, Vol. 11, No. 8, pages 4397-4407. However, the use of a fibre combiner increases the complexity, cost and size of the system. Thus, in a particularly preferred implementation the fibre-coupled lasers illuminate the focal volume without the use of a fibre combiner. The present inventors have devised a particularly efficient way of achieving this in instances where illumination source 140-2 is configured to provide light sheet illumination. In this implementation, the different fibres are arranged side-by-side in a closely spaced horizontal array, as shown in FIGS. 5A-5C. In FIG. 5A, optical fibre 501 carries blue laser light at a wavelength 488 nm, optical fibre 503 carries red laser light at a wavelength of 640 nm, and optical fibre 505 carries far-red laser light at a wavelength of 740 nm. The lasers are stably maintained in their side-by-side configuration through use of a mounting block 509, depicted in FIG. 5C. Mounting block 509 includes top plate 509-1 and bottom plate 509-2 which sandwich and clamp fibres 501, 503 and 505 within siting channels 509-3. In this case, siting channels 509-3 are V-grooves to allow easy compatibility with different sizes of optical fibres, but the skilled reader will appreciate that different channel profiles will also work. The lateral distance between the fibres is relatively small, with the distance between the centre line of adjacent fibres being no more than 3 times the sum of the radii of adjacent fibres, no more than 2 times the sum of the radii of adjacent fibres, no more than 1.5 times the sum of the radii of adjacent fibres, no more than 1.2 times the sum of the radii of adjacent fibres, or no more than 1.1 times the sum of the radii of adjacent fibres, nor more than 1.05 times the sum of the radii of adjacent fibres. For example, the spacing between the centre line of adjacent fibres may be less than 500 μm, less than 300 μm, less than 200 μm, or less than 150 μm. Differently stated, the gap between adjacent fibres may be less than 100 μm, less than 80 μm, less than 60 μm, less than 40 μm, less than 20 μm, less than 10 μm, or less than 5 μm.

In this way, the output from the fibres displays a high degree of overlap in the horizontal plane, so that the light sheets from all of 501, 503 and 505 illuminate all of the cross-sectional area of microfluidic channel 121. Positioning optical fibres 501, 503 and 505 in close proximity also allows the use of a small shared cylindrical lens 507, in this case having dimensions of 1.5×1.5×12 mm, to convert the fibres' output into light sheets focussed at the centre of microfluidic channel 121, as depicted in FIGS. 5A and 5B. This arrangement allows a particularly space- and cost-efficient construction, avoiding the need for expensive and bulky beam combining equipment, and allowing the use of a single cylindrical lens which again not only saves bulk and expense, but also allows easy alignment of the beams in the z-direction. The use of mounting block 509 further simplifies construction, and aids alignment of the beams.

During the movement of the target biochemical component 10 along the observation section 121, the emission 11 collected from the target biochemical component 10 impinges on a predetermined area on the detector 150. The predetermined area is smaller than the area of the image produced by the target biochemical component 10 moving in transverse direction in the field of view at the focal plane of the imaging lens 130. Therefore, an enhanced signal-to-noise ratio can be achieved if a higher amount of photons can land on a smaller area of the detector 150.

When the target biochemical component 10 moves through the focal volume of the imaging lens 130, the emission 11 collected from the target biochemical component 10 is imaged onto an area around a fixed point on the detector 150 for an extended duration. In other words, on the detector 150, the photons emitted by the target biochemical component 10 during the entire travel from out-of-focus, to in-focus then again to out-of-focus are imaged within the predetermined area on the detector 150.

For example, when the target biochemical component 10 is at the focal plane of the imaging lens 130, the area on the detector 150 corresponds to the point spread function of the imaging system provided by the imaging lens 130 and the optics between the imaging lens 130 and the detector 150. When the target biochemical component 10 is slightly away from the focal plane of the imaging lens in the z-direction, the area on the detector 150 is enlarged compared to the area at the focal plane.

Although the emission 11 may be dispersed on a number of pixels of the detector 150, when the target biochemical component 10 is slightly out of focus, these signals can still be assigned to or attributed to an individual target biochemical component 10. Therefore, the use of the section 121 along with the imaging lens 130 with the central axis 131 aligned with the flow direction leads to an enhanced signal-to-noise ratio and an extended observation time of individual target biochemical components 10. For example, the emission 11 during the movement through the focal volume in the section 121 can be integrated and accumulated on the same pixels if an enhanced signal-to-noise ratio is desired.

This is in contrast to the case where the imaging lens 130 is focused on the part of the microfluidic channel 120 where the target biochemical component 10 moves laterally, for example, in the y-direction in FIG. 1. In that case, the target biochemical component 10 may stay in the focal plane of the imaging lens 130 during the movement, but the emission 11 collected is imaged onto the detector 150 in an elongated area. The elongated area of the image occupies a number of pixels larger than the case described in FIG. 1, this leads to a reduced signal-to-noise ratio. Imaging lateral, high velocity flow often smears the signal across the pixels of the detector 150. When relatively small DNA/RNA particles are the target biochemical component 10, the signal is generally too weak when lateral flow is imaged.

In some implementations, the imaging lens 130 may be arranged such that the flow of the sample solution within the section 121 is aligned to coincide with a central axis 131 of the imaging lens 130. In particular, the flow is arranged to be parallel to the central axis 131 of the imaging lens 130 and the cross section in the yz-plane within the section 121 is centrally aligned such that the cross section of the section 121 at the focal plane of the imaging lens 130 is imaged onto the detector 150. In this case, during the entire movement, the centre of the image formed by the emission 11 is fixed at a point on the detector 150 and only the area of the image changes. However, the area does not change significantly because signals that originate far away from the focal volume contribute relatively less to the image.

In some implementations, the section 121 extends vertically with respect to gravity, and the imaging lens 130 is disposed below the section 121, again with respect to gravity.

The optical power of the illumination source 140-1, 140-2, the flow rate of the sample solution within the section 121 of the microfluidic channel 120, the exposure time, the numerical aperture of the imaging lens 130 can be adjusted such that the signal is sufficiently high to be detected as the target biochemical component 10 moves upwards or downwards through the focal volume of the imaging lens 130 and all photons 11 from the target biochemical component 10 will be integrated over the same area on the detector, e.g. an sCMOS camera, and results in a round spot similar to the point spread function (PSF) of a point source.

In some implementations, the imaging lens 130 may be arranged such that the flow of the sample solution within the section 121 is aligned to be at an angle with the central axis 131 of the imaging lens 130.

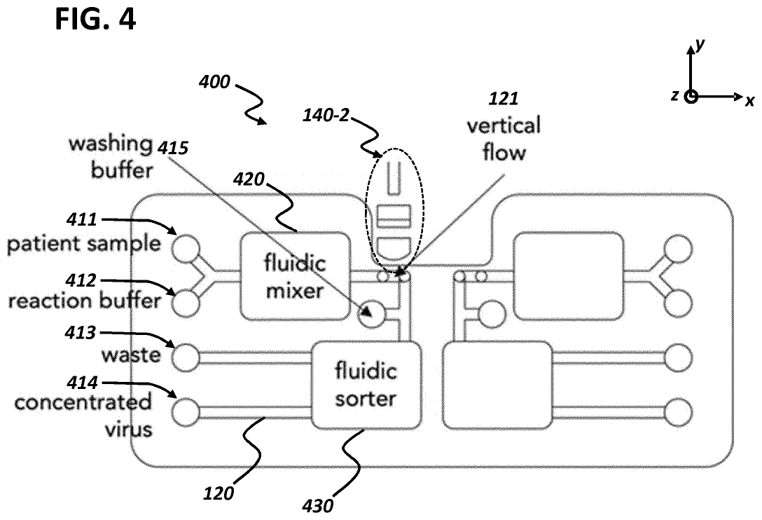

If the flow has a slight lateral component, for example, 25 degrees relative to the central axis 131 of the imaging lens 130, the spot on the detector 150 will turn into a line. A misalignment between the central axis 131 of the imaging lens 130 and the direction of the sample solution within the section 121 is tolerated as long as the emission 11 from the target biochemical component 10 can be imaged with acceptable signal-to-noise ratio. The imaging lens 130 may be chosen and the conditions may be set to enable detecting a single fluorophore molecule. For example, the imaging lens 130 may be a high NA oil objective lens or a low NA air objective. For another example, the tilt between the central axis 131 and the flow direction can be adjusted for the shallower focal volume, for example by aligning them to be parallel to each other. For another example, the flow velocity may be adjusted to be slower to enhance the signal-to-noise ratio. A controlled degree of tilt between the flow within the section 121 and the central axis 131 of the imaging lens 130 can be introduced for a colour barcode scheme, which will be described in more detail later. The microfluidic channel 120 is designed such that the flow is laminar. For example, the microfluidic channel 120 may be configured to support a flow rate of up to 10000 nanolitres per second (nl/s), up to 5000 nl/s, up to 2000 nl/s, up to 1000 nl/s, 500 nl/s, up to 400 nl/s, up to 300 nl/s, up to 200 nl/s, or up to 100 nl/s. The lower limit for the flow rate may be, for example, 1 nl/s, 5 nl/s, 20 nl/s, or 50 nl/s. Suitably, the flow rate is chosen so as to achieve rapid screening of the sample solution, whilst maintaining laminar flow and allowing target biochemical components to spend a sufficient time within the sample volume to generate a detectable signal. A suitable range for the flow rate may be, for example, 1-200 nl/s, 5-150 nl/s, or 20-100 nl/s. In certain instances, the flow rate may be 100 nanolitre per second. A microfluidic chip containing the microfluidic channel 120 will be discussed in more detail in FIG. 4.

In case the illumination beam 141-1 is sent into the vertical section 121 via the imaging lens 130, the optical element 140 is configured such that at least part of the illumination beam 141-1 is at least partially reflected when incident on the optical element 140 and directed to the imaging lens 130.

The optical properties of the target biochemical component 10 or the complex formed with the target biochemical component 10 allows optical imaging at the wavelengths of the illumination source 140-1, 140-2. Upon excitation by the illumination beam 141-1, 141-2, the target biochemical component 10 or the complex may emit light 11 depending on the mode of detection or the detection schemes. For example, the target biochemical component 10 or the fluorescent marker or the optical marker included in the complex may emit light via fluorescence, Raman scattering and Rayleigh scattering, among others. Each of these schemes may require a different configuration of the illumination source 140-1, 140-2, the detector 150 and the optical element 160.

The optical element 160 is configured to provide an optical path for the light collected from the target biochemical component 10 or the complex via the imaging lens 130 towards the detector 150 of the detection apparatus, separated from the optical path for the illumination beam 140-1, 140-2. The examples of the optical element 160 may include a beam splitter, a polarisation beam splitter, a dichroic mirror and a polychroic mirror although the optical element 160 is not limited to these examples.

In some implementations, when the target biochemical component 10 or an imaging probe hybridised to the target biochemical component 10 to form the complex includes fluorescent molecules, the optical element 160 may be configured as a dichoroic or a polychroic, which is configured to reflect the light at the wavelength of the excitation beam or the illumination beam 140-1, 140-2 incident on the optical element 160 and transmit the light at least one of the wavelengths of the fluorescence light emitted from the target biochemical component 10. The fluorescence light collected by the imaging lens 130 may arrive at the detector 150 after being transmitted at the optical element 160.

In some implementations, when the target biochemical component 10 or the imaging probe hybridised to the target biochemical component 10 is to be detected via scattering, the optical element 160 may be configured as a beam splitter or a polarisation beam splitter at the wavelength of the excitation beam 140-1, 140-2 and of the scattered light. Both the reflected excitation beam 140-1, 140-2 and the scattered light may reach the detector 150 after being transmitted at the optical element 160.

In some implementations, the illumination source 140-1, 140-2 may be configured such that the entire cross section in the xy-plane of the section 121 at the focal plane of the imaging lens 130 is illuminated.

In some implementations, the illumination source 140-2, 140-2 may be configured such that a part of the cross section in the xy-plane of the section 121 at the focal plane of the imaging lens 130 is illuminated. For example, only the centre of the flow in the section 121 may be illuminated. For another example, a structured illumination with a pattern in the xy-plane at the focal plane may be used.

It is understood that additional optics for imaging may be introduced as necessary in addition to the components described in FIG. 1. For example, when the imaging lens 130 is infinity corrected, a tube lens is included either within the detector 150 or in the beam path between the optical element 160 and the detector 150.

The detector 150 may be a multi-pixel detector or a multi-array detector such as a CCD, an EMCCD, a CCD, and a sCMOS. The collected light 11 over the illuminated area within the section 121 is optically imaged onto the detector 130 over a plurality of pixels. In this case, the portion of the sample 10 at the out-of-focus plane 113 leads to a signal distributed over a larger number of pixels than the signal of the portion from the focal plane.

In some implementations, the detector 150 may be an array of single pixel detectors such as an avalanche photodiode (APD), a photomultiplier tube (PMT) or a superconducting nanowire single-photon detector (SNSPD).

In instances where the target biochemical component emits a light signal at multiple wavelengths, the detection apparatus may comprise optical components to resolve those different wavelengths. For example, the detection apparatus may comprise one or more optical filters (a dichroic filter, polychroic filter, longpass filter, bandpass filter, or combinations thereof) to separate light signals into two or more colour channels. The different colour channels may be detected on separate detectors. Alternatively, the different colour channels may be detected on separate areas of a single detector. For example, for two-colour channel imaging the emission may be split so that one colour channel is directed to one half of the camera detector, and another camera channel is directed to the other half of the camera detector. For, three or four colour imaging, the camera detector may be split into quarters, in an analogous fashion. The skilled reader is aware of how to achieve this using suitable optical components, and commercially available splitters are available to achieve this configuration, such as the Dual-View™ and Quad-View™ systems from Optical Insights, LLC.

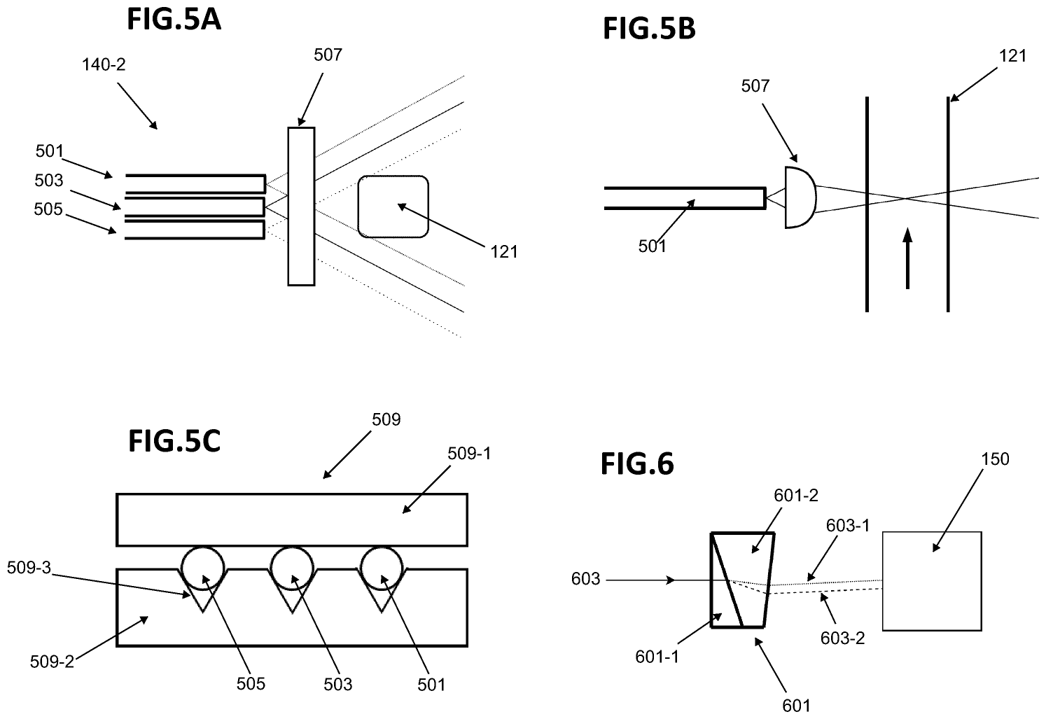

Additionally, or alternatively, the detection apparatus may comprise a dispersive element (such as a prism or grating) to spectrally spread the emitted light such that different wavelengths illuminate different parts of a detector. FIG. 6 shows a dispersive element suitable for such embodiments, taking the form of a doublet compound prism 601. Alternatively, singlet, triplet, or quadruplet prisms, or a combination of these, can be used. The compound prism 601 is a double wedge configuration, comprising first prism 601-1 and second prism 601-2, cemented together over their shared faces. The prisms are oriented in opposite directions to each other, with their apexes facing away from one another. Both are formed from optical glass, with first prism 601-1 having a relatively higher refractive index than second prism 601-2. The compound prism is designed such that incoming emission light 603 is spectrally spread within the prism, and then re-collimated before impinging on detector 150. The spectral spread can be adjusted through selection of the materials chosen for the first prism 601-1 and second prism 601-2, the angle of the face between the two prisms, and the thickness of the prisms. The angle of the exit facet can be modified to achieve a straight pass configuration in which the central wavelength does not deviate from the optical axis. In this case, the combination of the prism and detector is able to achieve 10 nm in wavelength for each pixel across a range of 680-790 nm. In this case the point spread function (PSF) will be asymmetric due to the asymmetric spectra of emission from different fluorophores. Different fluorescent labels will have different shapes for the PSF. The shape of the PSF can be used to detect and distinguish multiple fluorescent labels. This can enable the detection and distinction of all fluorescent labels of different colours simultaneously.

For example, consider a situation where the target biochemical component is labelled with one of a first fluorescent label or a second fluorescent label, the fluorescence emission from which is detectable on the same colour channel of a detector. In the absence of a dispersive element, the fluorescence from the two fluorescent labels may be indistinguishable due to them having the same PSF in the colour channel of the detector. However, with the dispersive element (prism) present, the PSF of the two fluorescent labels is different, allowing the fluorescent labels to be distinguished.

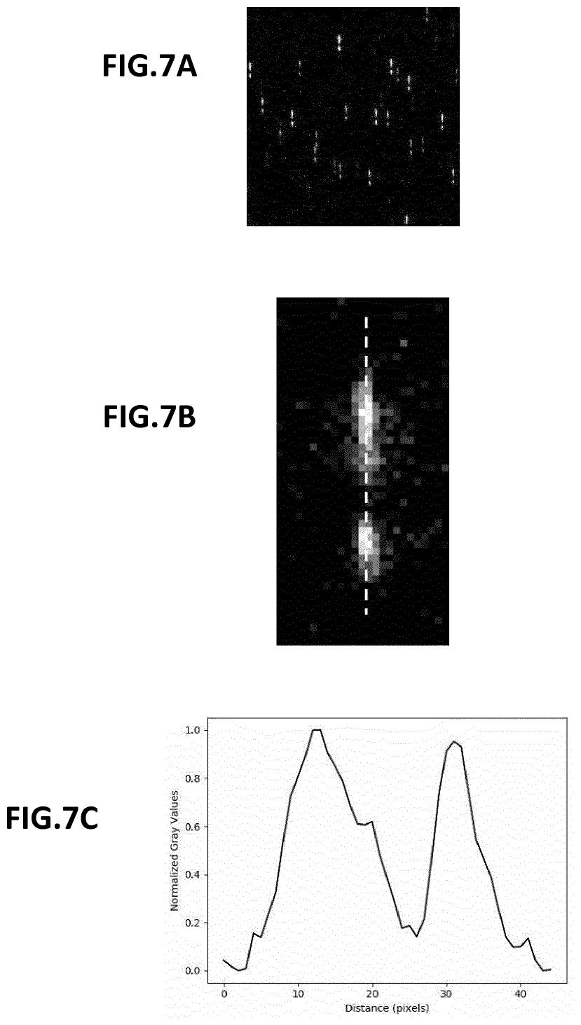

In the implementation depicted in FIG. 7 the spatial displacement of the spectrum is in the vertical direction. However, displacement of the spectrum can be in any direction depending on the orientation in which the prism is inserted into the optical pathway. With the prism, Foerster resonance energy transfer (FRET) associated signals will also be spatially displaced. Thus, the dispersive element can permit FRET detection, even in the absence of additional optical filters. Using the dispersive element for FRET measurements can allow the detection of multiple fluorophores in a single colour channel of the detector using a single laser, thereby reducing the cost of implementation and increasing the field of view visible by the detector.

The efficacy of this methodology is demonstrated in FIG. 7A-7C. FIG. 7A shows a camera image of fluorescent emission from 100 nm fluorescent beads dual-labelled with Alexa Fluor 488 and Alexa Fluor 568, where the emission has been spectrally separated using a prism as shown in FIG. 6. Images are acquired with a 488 nm laser which excites Alexa Fluor 488 and Alexa Fluor 568 simultaneously. The prism is arranged such that the emission is spread vertically on the camera with longer wavelengths towards the bottom, such that the emission of Alexa Fluor 488 appears above that of Alexa Fluor 568 for each detected bead. FIG. 7B shows a close-up of emission from a single bead of FIG. 7A, and demonstrates the asymmetric PSF of both fluorescent labels. This asymmetric PSF is clearly shown in FIG. 7C, which shows a line scan of pixel intensity across the dotted line of FIG. 7B.

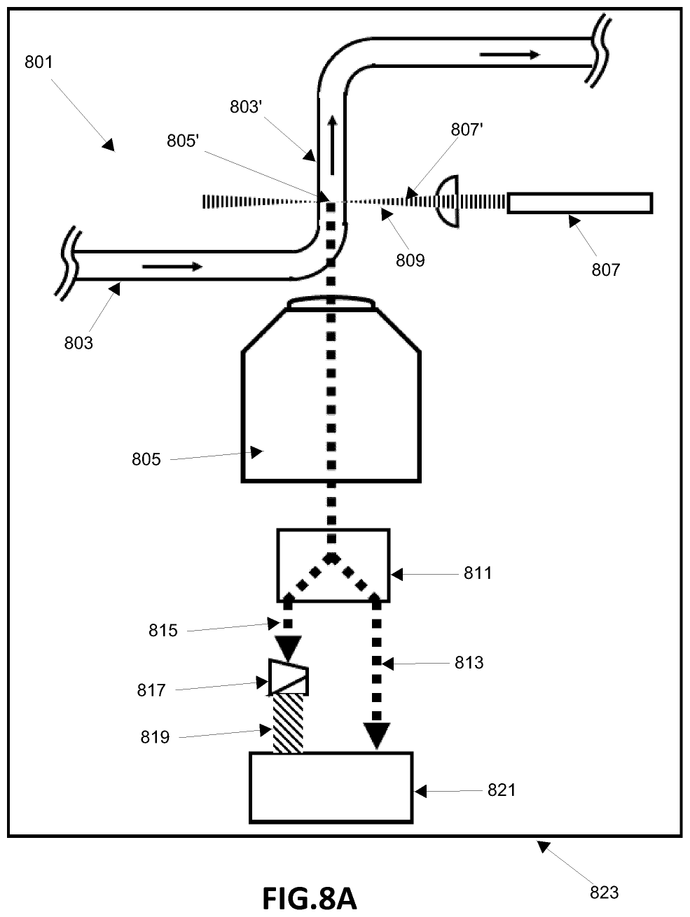

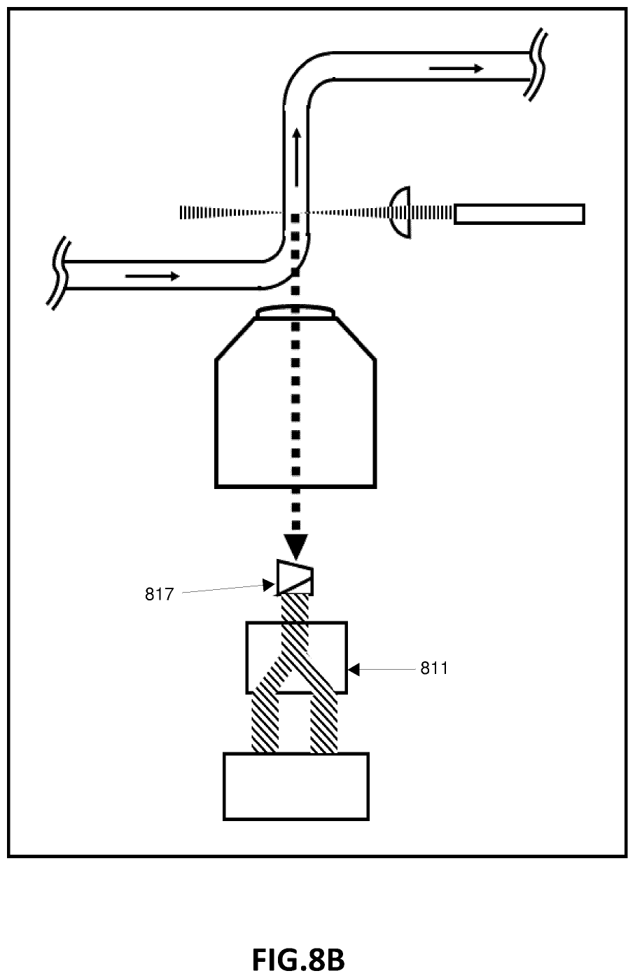

FIG. 8A depicts a particularly preferred implementation of the detection system, suitable for detecting the presence of target biochemical components through light sheet fluorescence microscopy (LSFM). The fluorescence imaging system 801 comprises a microfluidic chip incorporating a microfluidic channel 803 having a section 803′ running vertically along the central lens axis of objective lens 805. In this case, the objective lens is a 20× magnification 0.45 numerical aperture objective, since they are generally cheaper and simpler to use than higher powered air- or oil-immersion objectives, but the skilled reader will recognise that the implementation of FIG. 8A will work with the alternative objective lenses mentioned above. The diameter of the microfluidic channel 801 is slightly less than the width of the focal volume 805′ of objective lens 805. The system 801 incorporates a laser system 807 comprising three fibre-coupled lasers with a single associated cylindrical lens 809 (arranged in the manner depicted in FIG. 5A) which forms the output of the lasers into overlapping light sheets 807′ focussed at the centre of the microfluidic channel section 803′. Although three fibre-coupled lasers are used in FIG. 8A, the skilled reader will recognise that other numbers of lasers are possible (for example, two or four). The thickness of the light sheet 807′ is approximately 10 μm which is the same as the thickness of the focal volume 805′. Fluorescence emission arising within the focal volume 805′ is collected by objective lens 805 and fed to an image splitter 811, which uses a longpass dichroic mirror (not shown) to separate red emission 813 from green/orange emission 815. The red emission is then directed to one half of camera 821. The green/orange emission is directed to a prism 817 (as depicted in FIG. 6) which spreads the emission into a spectrum 819 which is then directed to the other half of camera 821. Although the prism in the system depicted in FIG. 8A is associated with only the green/orange channel, in other preferred implementations the prism may be positioned so that it spans both the green/orange channel and the red channel, to disperse the signal in both colour channels. All of the components are enclosed in light-proof housing 823, which limits the detection of ambient light by the detector 821.

In the alternative implementation shown in FIG. 8B, all of the components are identical to FIG. 8A, but prism 817 is now positioned ahead of the image splitter 811, thereby allowing the detection of spectra on both halves of the camera. This can permit spectral separation and identification of even more fluorophores than in FIG. 8A.

Although the descriptions of FIG. 8A and FIG. 8B describe the use of longpass dichoric mirrors and prisms to separate colours, the skilled reader will appreciate that similar effects can be achieved through using alternative optical filters and dispersive elements (e.g. gratings).

Advantageously, the particular implementations depicted in FIG. 8A and FIG. 8B can be made from relatively cheap and simple components, can be made relatively compact (in particular through the use of the compact laser source discussed in relation to FIG. 5A-C), and can be straightforward to keep in alignment. For these reasons, this implementation is particularly well-suited to use in the field of low cost rapid diagnostic screening of pathogens, such as viruses.

FIG. 2 is a flowchart illustrating a method of detecting a target biochemical component.

In step 210, a sample solution is prepared by adding a buffer solution to a sample containing the target biochemical component 10.

The examples of the target biochemical component 10 include DNA or RNA, for example with more than 1000 nucleotides, such as the ssRNA of SARS-CoV-2 (CoV).

However, the method is not limited to the target biochemical component 10 being DNA or RNA, if provided with probes labelled or hybridised to the target biochemical component 10. The method can be generalized to any target biochemical component which can be labelled with an optical probe. Also intact virus can be directly labelled as will be discussed later.

Hybridisation with Detection Probe and Imaging Probe.

In some implementations, when the target biochemical component comprises one or more of a DNA and an RNA and the buffer solution may comprise a lysis buffer containing one or more RNAase inhibitors to release the target DNA or RNA into the sample solution.

In some implementations, when the target biochemical component 10 comprises an infectious agent, the preparing the sample solution further comprises heat activation.

In some implementations, the buffer solution comprises one or more detection probes DP and one or more imaging probes IP. The detection probe DP is configured to hybridise with the target biochemical component 10. The detection probe DP is typically 50 nucleotides, which hybridize to the target biochemical component 10 directly with a matching region of around 20 base pairs.

The detection probe DP comprises a non-binding region, or a non-binding “overhang” configured to hybridise with the imaging probe IP. The IPs are typically around 20 nucleotides. The imaging probe IP is labelled with one or more optical markers suitable for optical imaging, for example, one fluorescent dye on the 5′ and 3′ ends each with different spectral properties. The examples of the optical marker include a fluorescent dye molecule, a semiconductor quantum dot, or a nanoparticle although the optical markers are not limited to these examples.

In some implementations, the detection probes DP and the imaging probes IP are not included in the buffer solution but are added after the sample solution is mixed with the buffer solution comprising the lysis buffer. Since patient samples can be a high volume, only a fraction of the mixture of the patient sample and the buffer solution is used for hybridising with the detection probes DP and the imaging probes IP in a separate reaction step such that a high concentration of the detection probes DP and the imaging probes IP can be achieved. This may lead to a more efficient reaction for hybridisation and provides a more cost-effective solution.

For example, 500 microlitre of the patient sample can be mixed with 500 microlitre of lysis buffer to release the DNA or RNA. Then 10 microlitre of this mixture can be mixed with 10 microlitre of solution containing the detection probes DP and the imaging probes IP.

In some implementations, the detection probes can be designed such that the same imaging probe IP sequence binds to multiple detection probes DP.

In some implementations, the imaging probe IP may be chosen to be suitable for optical detection in the detection system 100. Different detection probes DP may be designed and used for detecting a different target biochemical component 10. The imaging probe IP can be designed to hybridise to multiple detection probes DP similar to the practise of using the same secondary antibodies to stain different primaries in immunofluorescence assays. For example, the same imaging probe IP may be used to label DPs bound to both influenza and SARS-CoV-2 ssRNA.

In some implementations, the detection probes DP against a certain target may be designed to bind a unique ratio of imaging probes IP of multiple colours. Fluorophores of different colours and fluorescence intensities in different spectral regions can be found on the individual target biochemical components 10 which can encode the identity of the target in a multiplexed assay.

In some implementations, when the target biochemical component 10 comprises a DNA or an RNA, the detection probe DP comprises nucleic acid oligomers.

The oligomers comprised by the detection probe DP and the imaging probe IP can be DNA, RNA, PNA (peptide nucleic acid) or LNA (locked nucleic acid) to achieve faster hybridisation, for example because the probes lack any secondary structure as in the case of LNA.

As a result of hybridisation, within the sample solution, a complex containing the target biochemical component 10, the detection probe DP and the imaging probe IP, is formed.

In some implementations, when the optical marker of the imaging probe IP comprises fluorescent molecules, the buffer solution comprises an imaging buffer configured to prevent photobleaching of the fluorescent molecules.

In some implementations, the buffer solution comprises one or more directly labelled detection probes DLDP. The directly labelled detection probe DLDP is typically 20 nucleotides, which includes optical markers or labels at the 3′ and 5′ ends. This may provide a simpler assay compared to the assay involving both the detection probes DP and the imaging probes IP.

The directly labelled detection probe DLDP is configured to hybridise with the target biochemical component 10 directly with its nucleotide sequence being complementary to a region on the target molecule. Quenching probes QP have complementary sequences to the directly labelled detection probes DLDP. The quenching probes QP can be added to the sample solution after the directly labelled detection probes DLDPs are hybridised to the target biochemical component 10 to quench the background fluorescence from the non-bound directly labelled detection probes DLDPs. This may alleviate the degree of purification required. For example, the directly labelled detection probe DLDP can be 5′-GCATGCAGCCGAGTGACAGC-3′ (SEQ ID NO: 1) and have Cy5 dye on its 5′ and 3′ ends. The quenching probe QP can have the following sequence: 5′-GCTGTCACTCGGCTGCATGC-3′ (SEQ ID NO: 2) and have “Black Hole Quencher” dyes on the 5′ and 3′ ends. This sequence of the directly labelled detection probe DLDP sequence is complementary to a part on the CoV RNA genome.

Direct Labelling of Virus

In some implementations, instead of lysing the virus and freeing the RNA to be hybridised with one or more of the detection probes DP, the imaging probes IP, and the directly labelled detection probes DLDP as discussed above, intact virus may be directly labelled as the target biochemical component 10 and directly detected optically in the sample solution.

In order to directly label viruses which are enveloped and negatively charged in aqueous solutions, like the plasma membrane of cells, one can add positively charged ions from metal salts to the solution which preferentially chelate to the negatively charged viruses, and subsequently add negatively charged labelled probes which chelate to the positively charged metal ions.

For example, to the sample solution, ZnCl₂ can be added and labelling probes LP, approximately 50 nt ssDNA oligomers which are labelled at 3′ and 5′ ends, can be added. Although the binding is not specific to any one type of enveloped virus, such as SARS-CoV-2, but also to other types of viruses, such as Influenza A, multiple fluorophores can be used with different colours, such as blue, green, red, on different DNA sequences with different lengths, single stranded or double stranded.

Different sequences may have different binding kinetics to SARS-CoV-2 as the target chemical component 10 compared to other enveloped vesicles such as flu virus and Respiratory syncytial virus (RSV). This can be due to sequence dependent difference of the secondary structure (the geometrical shape) of the DNA phosphate backbone. Fast binding kinetics requires the DNA shape to be matched with the spatial distribution of anionic moieties and therefore metal cations on the surface of the virus. Different viruses will also bind a different amount of labelling probes LP, for example because viruses have different surface area. For example, flu virus is 80-120 nm in diameter and may bind to an average of 10×50 nt oligomers, whereas RSV with a size of 120 nm-200 nm may bind 30×50 nt oligomers. Oligomers of shorter length, e.g. 20 nts might bind to certain viruses where the anionic moieties on the virus' surface are within the distance spanned by the shorter DNA backbone. Such DNA oligomers can be labelled with a specific fluorophore colour, e.g. a blue version and a red version, so that we can identify the specific virus which is able to bind 20 nts DNA oligomers can be uniquely distinguished versus a virus which may only bind longer sequences because the surface anions are distributed further apart. Note that there can be a critical number of anions and chelated metal cations required for DNA oligomers to bind due to highly cooperative binding of metal cations to the DNA phosphate backbone. On different viruses. the distance between fluorophores on the chelated DNA might different. If labelling probes LP with different colour fluorophores are used, Foerster resonance energy transfer (FRET) may occur and different virus particles may be distinguished via different FRET efficiencies.

Therefore, different viruses can be distinguished because they bind 1. differently depending on the length of the sequence, 2. differently to different sequences of the same length, 3. different total copies of labelling probes LP. Therefore they can be distinguished based on a. different fluorescence intensities in each colour, b. different FRET efficiency c. different total intensity.

Ca2+ mediated binding to DNA can be a cooperative process. If Ethylenediaminetetraacetic acid (EDTA) is supplemented to a solution of virus, labelled DNA and Ca2+, where the labelled DNA is bound to the viruses, the binding diminishes, even if 10× less concentration of EDTA is used compared to Ca2+ concentration. Usually, a gradual quenching of DNA binding would be expected and complete quenching would be expected at 1:1 concentration with Ca2+. EDTA has a higher affinity to Ca2+ than virus or DNA.

In some implementations, Zinc ion, Zn2+, may be used, instead of Ca2+, in mediating binding between viruses with anionic surface moeities and DNA. Zn2+ may exhibit higher stability than Ca2+. Zn2+ mediated binding may also work in saliva, in addition to the pure solutions of virus. Saliva contains mucin with carboxylate groups which are negatively charged at pH>5, which may disrupt the binding between virus and Ca2+, or Ca2+ and DNA, or the cooperativity of binding.

Zn2+ mediated binding may render the binding more robust to competition with other Zn2+ binders in the sample solution since Zn2+ mediated binding does not exhibit cooperativity.

Therefore, Zn2+ can be used in saliva or nasal fluid as the sample solution and the high efficiency with which Zn2+ mediates binding between virus and DNA leads to a high number of labelling probes LP bound to the target virus, which leads to high brightness in the optical signals.

Due to this high efficiency, Zn2+ may also mediate binding between extracellular vesicles (EVs), including exosomes and labelled DNA. Therefore, extracellular vesicles can also be labelled using Zn2+. 0.1% of non-ionic surfactant, can disrupt the extracellular vesicles so that the Zn2+ labelled particles are less bright. In this case, smaller membrane fragments can be labelled as opposed to whole extracellular vesicles.

Due to high efficiency, the optical signal from Zn2+/virus/labelling probes LP may be obtained within seconds. The optical detection system 100 on microfluidic platform as described herein facilitates observation of such binding events.

In some implementations, by adjusting the concentration of the non-ionic surfactant, the target virus can be detected while extracellular vesicles present in many samples such as saliva are not detected. Since saliva contains a lot of extracellular vesicles, detecting virus which are usually present at much lower concentration the extracellular vesicles in saliva may be possible when the signal from extracellular vesicles is sufficiently suppressed. For example, 0.1% of non-ionic surfactant may not enough to lyse viruses but enough to lyse extracellular vesicles. In the case of saliva, it is advantageous to disrupt the mucin network which can bind to virus, metal cations, or DNA and interfere with the assay. Adding redox reagents such as Dithiothreitol (DTT) reduces the disulfide bonds between mucins and adding EDTA removes Ca2+ which mediates links between mucins.

In some implementations, a combination of Calcium ions, Ca2+, and strontium ions, Sr2+, may be used at a predetermined ratio in mediating binding between vesicles with anionic lipids and DNA. Ca2+ by itself in a solution containing a virus and labelling probes LP leads to aggregation after a few minutes. Aggregation may happen when the DNA bridges Ca2+ ions bound to another virus particle. We have observed that a solution with 10 mM Ca2+ and 10 mM Sr2+ reduces aggregation of virus particles. However, this solution is metastable and spontaneously undergoes a phase transition such that the signals from the labelling probes LP on the target virus disappear. At 2:1 ratio of Ca2+ and Sr2+ the solution is both stable and reduces formation of virus aggregates.

Compared to the case where only Ca2+ is used, Sr2+ may compete with Ca2+ in binding to virus and DNA such that Ca2+ mediated aggregation of the virus may be alleviated. When measured with EDTA which chelates Ca2+, Strontium seems to have a weaker affinity to DNA and viruses than Calcium. Since Calcium-mediated binding is deemed to be highly cooperative, when even a fraction of Calcium ions are replaced, for example 3%, by competitors, the binding rate may dramatically decrease. At a 1:1 ratio, Sr2+ seems to be able to replace more than 3% of Ca2+ from virus-DNA interactions.

In step 220, the sample solution is purified to select the complex containing the target biochemical component 10.

Free detection probes DP, imaging probes IP and detection probe-imaging probe complex, DP-IP, are removed and the detection probe-imaging probe-target biochemical component complex DP-IP-T is purified for detection step. In particular, the detection probe-imaging probe complexes DP-IP and imaging probes IP need to be filtered in this step as they would otherwise give rise to a high background in optical detection. Therefore, the detection probe DP and the imaging probe IP can be provided at a high concentration to enable fast hybridization with the target biochemical component 10, while the background is suppressed. For example, the fluorescence of unbound detection probe-imaging probe complex DP-IP and imaging probes IP can be prevented to enhance the signal-to-noise of the specific detection of the target biochemical component 10.

In some implementations, when directly labelled detection probes DLDP are used, the directly labelled detection probes DLDP not bound to the target biochemical component 10 may be filtered.

In some implementations, when viruses are directly labelled by adding cationic solution and labelling probes LP, anionic vesicles labelled with the labelling probes may be filtered.

In some implementations, the sample solution may be purified via manual column chromatography. In this case, purified sample solution may be manually inserted in to the microfluidic channel 120.

In some implementations, the sample solution may be purified through a size exclusion column (SEC) as the purifying unit 110.

In some implementations, the sample solution may be purified by high performance liquid chromatography (HPLC). The sample solution may be purified through a high performance liquid chromatography (HPLC) device as the purifying unit 110.

In step 230, the sample solution is sent into a microfluidic channel 120 configured to support a flow of the sample solution. The microfluidic channel 120 connected to the output of the purifying unit 110.

In some implementations, the high performance liquid chromatography (HPLC) device 110 may be configured to receive multiple sample solutions with a time delay between each type of target biochemical component 10 and distribute the purified output correspondingly in time.

In some implementations, when the high performance liquid chromatography device is used, each output can be correlated with different types of labelling of the target biochemical component 10.

In some implementations, when the high performance liquid chromatography device is used, each output may be from different patients and the high performance liquid chromatography device may be connected to multiple units of microfluidic channels 120, such that the purified sample of each patient can be analysed on different microfluidic channels 120.

In some implementations, when the high performance liquid chromatography device is used, each output may be from different patients and the high performance liquid chromatography device may be connected to multiple units of a combination of the microfluidic channels 120 and an optical imaging unit including the imaging lens 130, the optical element 140 and the detector 150, such that the purified sample of each patient can be analysed in parallel and the throughput is increased. The size exclusion column (SEC) can either be used in the centrifuge, or on a vacuum line that is integrated into the fluidics system which includes the microfluidic channel 120 on the detection system 100.

In step 240, the complex is detected by imaging the one or more imaging probes IP or labelling probes LP included in the target biochemical component 10 in the section of the microfluidic channel.

As explained in FIG. 1, the flow in the section 121 within the microfluidic channel 120 is aligned with respect to the central axis 131 of the imaging lens 130 such that the emission 11 from individual ones of the target biochemical component 10 traverses the focal volume along the central axis 131 of the imaging lens 130 during the movement of the complex along the section 121.

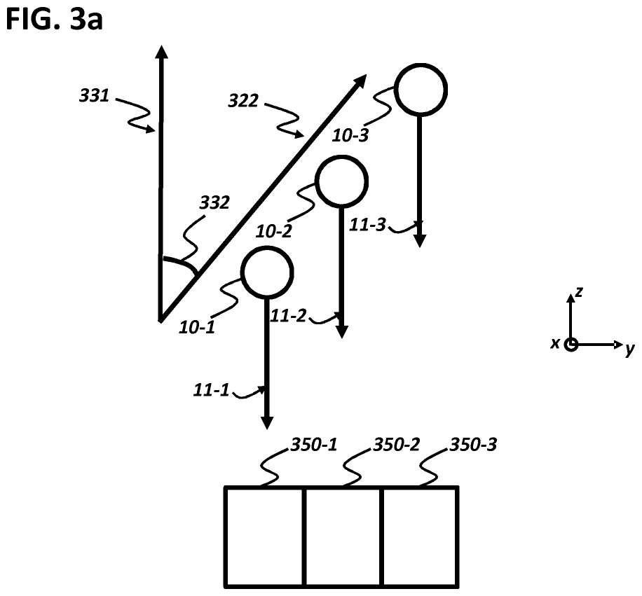

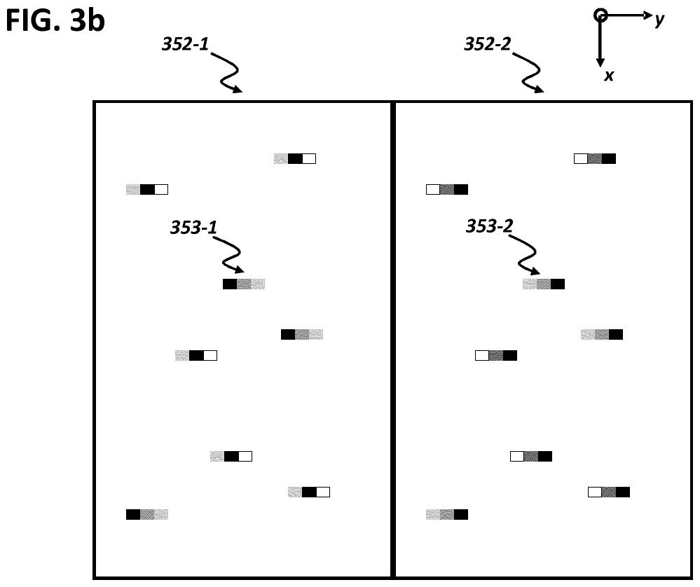

In some implementations, the target biochemical component 10 can be detected using an optical barcode scheme described in FIGS. 3a and 3b.

FIG. 3a is a schematic that illustrates an optical barcode scheme.

Using the detection system 100, an optical barcode scheme can be implemented as part of step 240, as explained below.

The imaging lens 130 and the observation section 121 of the microfluidic channel 120 are aligned with respect to each other such that a central axis 331 of the imaging lens 130 and a flow direction 322 within the section 121 are at an angle 332.

Although the central axis 331 and the flow direction 322 are not parallel, the angle 332 or a degree of the tilt 332 between the central axis 331 and the flow direction 332 is kept under a predetermined value such that the target biochemical component 10 being imaged travels through the focal volume axially, from out-of-focus to in-focus, then to out-of-focus and is imaged on the detector within a predetermined area on the detector 150, as explained in FIG. 1.

For example, as shown in FIG. 3a, the movement of the target biochemical component 10, primarily in the z-direction with a slight tilt towards the y-direction, is imaged as an area elongated in the y-direction on the detector 150. The degree of tilt is such that the target biochemical component 10 passes through the focal plane of the imaging lens 130. Therefore, the movement is largely in the axial direction, z-direction.

In the example of FIG. 3a, as the target biochemical component 10 travels within the section 121, moves from a first position 10-1, to a second position 10-2, then to a third position 10-3 within the section 121.

The first to third position 10-1, 10-2, 10-3 are within the focal volume of the imaging lens 130. Alternatively, the first position 10-1 and the third position 10-3 may be slightly away from the focal-volume such that they are slightly out of focus but near the focal plane of the imaging lens 130 such that it can be imaged on the detector 150.

Since the flow direction 322 is tilted with respect to the central axis 331, the target biochemical component 10 is imaged at different positions on the detector 150 at each of the first position 10-1, the second position 10-2, and the third position 10-3. In the example of FIG. 3a, the first to third positions 10-1, 10-2, 10-3 are aligned in the y-direction, due to the tilt of the flow direction 322 towards the y-direction.

A first emission 11-1 from the first position 10-1, a second emission 11-2 from the second position 10-2, and a third emission 11-3 from the third position 10-3, collected by the imaging lens 130, impinge respectively on a first area 350-1, a second area 350-2 and a third area 350-3, which are part of a stripe 350 formed on the detector 150.

The degree of tilt or the angle 332 between the central axis 331 and the flow direction 322 may be determined considering the flow velocity within the section 121 of the microfluidic channel 120, the collection efficiency of the imaging lens 130, and the frame rate of the detector 150 such that the image obtained has an acceptable level of the signal-to-noise-ratio for optical detection.

The relationship between the depth of focus of the imaging lens 130, the flow velocity within the observation section 121, the degree of tilt, the exposure time of the detector 150, and the length of the observation section 121 are determined based on a desired level of throughput and speed. The length of the strip 350 on the detector 150 is fixed such that the colours can be distinguished. For example, if the assay needs to be performed within 3 minutes, the volume of the patient sample, for example, 20 microlitre, determines the flow velocity. The exposure time of the detector 150, for example a CCD camera, may be set to be the fastest, for example 10 ms for a full frame.

Then the imaging lens 130 is determined accordingly which has the appropriate magnification and the depth of focus to provide a focal volume for imaging, for example, 1 nanolitre per frame. For example, 20×0.45 NA objective lens can be used as the imaging lens 130. The degree of tilt is also determined to for a strip with a sufficient length and the depth of focus.

For the optical barcode scheme, the imaging probes IP or the labelling probe LP attached to the target biochemical component 10 is rendered to emit at a different colour at each of the first position 10-1, the second position 10-2 and the third position 10-3.

Although the example of FIG. 3a considers three positions 10-1, 10-2, 10-3 within the focal volume of the imaging lens 130 and three corresponding areas 350-1, 350-2, 350-3 of the strip 350 on the detector 150, the number of positions is not limited to three. As long as the signal-to-noise ratio allows, a larger number of the positions 10-1, 10-2, 10-3 within the focal volume and the areas 350-1, 350-2, 350-3 on the detector 150 can be used and the imaging optics and the degree of tilt 332 can be adjusted accordingly.

A plurality of wavelengths or colours may be used at the illumination source 140-1, 140-2. When the target biochemical component 10 is labelled with two or more kinds of the imaging probes IP or the labelling probes LP, the two or more kinds of the imaging probes IP or the labelling probes LP can be excited separately. For example, the illumination sources 140-1, 140-2 may be 488 nm, 561 nm, 640 nm lasers.

In some implementations, alternatively, the illumination source 140-1, 140-2 may emit a single wavelength and the imaging probes IP may be used, each of which emits at a different wavelength on excitation from the single wavelength excitation light 141-1, 141-2. For example, semiconductor quantum dots of varying sizes may be used as the imaging probes IP and a single blue laser may be used as the illumination source 140-1, 140-2.

The illumination source 140-1, 140-2 is configured to illuminate the target biochemical component 10 selectively at each of the first to third positions 10-1, 10-2, 10-3.

As explained in FIG. 1, the illumination source 140-1, 140-2 may be configured to illuminate the whole of the volume within the section 121 which is to be imaged on the detector 130. In this case, the selective addressing of one of the positions 10-1, 10-2, 10-3 can be achieved by illuminating with light pulses and by adjusting the initiation time point and the duration of the pulse. The illumination source 140-1, 140-2 is configured to emit corresponding pulses.

For example, to selectively excite the target biochemical component 10 at the second position 10-2, the illumination source 140-1 can emit a pulse after the target biochemical component 10 passes through the first position 10-1 and the pulse is terminated before the target biochemical component 10 arrives at the third position 10-3.

In some implementations, the illumination source 140-1, 140-2 may be configured to emit pulses with different wavelengths. The imaging probes IP of the target biochemical component 10 at each position 10-1, 10-2, 10-3 can be excited with a different wavelength.

In the example of FIG. 3a, where three positions 10-1, 10-2, 10-3 near the focal volume are considered and imaged on to the stripe 350 including three areas 350-1, 350-2, 350-3, the illumination source 140-1, 140-2 is configured to emit pulses with three different wavelengths for the first position 10-1, the second position 10-2, and the third position 10-3, respectively. For example, 488 nm, 561 nm, 640 nm laser pulses are used for the first position 10-1, the second position 10-2, and the third position 10-3, respectively.

In some implementations, the frame rate of the detector 150 may be configured to match the pulse duration and the illumination sources 140-1, 140-2 may be configured to emit pulses within the exposure time of a frame. For example, the frame rate of the detector 150 can be set such that at each frame the emission 11-1, 11-2, 11-3 of each position 10-1, 10-2, 10-3 is imaged on the detector 150. In this case, each frame can contain the image of the target biochemical component 10 at each position 10-1, 10-2, 10-3.

In some implementations, the detector 150 may be arranged such that the emission 11-1, 11-2, 11-3 may be read out in two or more spectral channels. The target biochemical component 10 may be labelled with two or more kinds of imaging probes IP or labelling probes LP, and the emission 11-1, 11-2, 11-3 therefore may contain two or more distinct spectrum corresponding to each of the imaging probes IP. Either using two or more separate detectors 150 or by using separated areas on the same detector 150 and with the help of optics such as optical filters and dichroic mirrors, the detector 150 can be arranged such that two or more distinct spectrum or colours of the emission 11-1, 11-2, 11-3 can be detected.

In some implementations, when the central axis 331 and the flow direction 322 is arranged to coincide with or be parallel with each other such that the angle 332 is zero, the optics between the imaging lens 130 and the detector 150 may be arranged to provide an asymmetric point spread function (PSF) in the z-direction such that the emissions 11-1, 11-2, 11-3 emanating from the first to third position 10-1, 10-2, 10-3, aligned in the z-direction, impinge on the strip 350 extending in the y-direction, respectively on the first to third areas 350-1, 350-2, 350-3.

Alternatively, a dispersive element (such as a grating or a prism) may be placed such that the emissions 11-1, 11-2, 11-3 with different colours emanating from the first to third position 10-1, 10-2, 10-3 impinge on the strip 350 extending in the y-direction, respectively on the first to third areas 350-1, 350-2, 350-3. FIG. 3b is a schematic for illustrating an example of optical barcode data.

In the examples of FIGS. 3a and 3b, the illumination sources 140-1 are assumed to be 488 nm, 561 nm, 640 nm lasers. These three wavelengths are pulsed to excite selectively at the first position 10-1, the second position 10-2, and the third position 10-3, as explained in FIG. 3a.

For illustration of the example of FIGS. 3a and 3b, the following imaging probes IP or labelling probes LP will be considered: Alexa488 dye to emit mainly on excitation with 488 nm (blue) laser, Cy3B dye to emit mainly on excitation with the 561 nm (green) laser and Cy5 dye (red), to emit mainly on excitation with the 640 nm (red) laser. A sequence of pulses 488 nm-561 nm-640 nm or blue-green-red is provided respectively for the first position 10-1, the second position 10-2 and the third position 10-3, as explained in FIG. 3a.

In some implementations, the target biochemical component 10 may be labelled with two or more kinds of the imaging probes IP or the labelling probes LP with a predetermined relative fraction.

For example, 200× detection probes DP can be applied to hybridise to the solution containing the target biochemical component 10 in step 210. The detection probes DP can be divided into three sets hybridizing to two different imaging probes IP. 2× of the imaging probes IP can be labelled with Cy5 dye and 1× of the imaging probes with Cy3B dye.

When these detection probes DP are hybridised to the target biochemical component 10, for example, a viral ssRNA from SARS-CoV-2, the emission 11-1, 11-2, 11-3 exhibits a unique ratio of intensities blue:green:red=0:1:2. Also when the binding sites of the detection probes DP are within the relevant distance, FRET (Fluorescence resonance energy transfer) between Cy3B dye and Cy5 dye, where on excitation with the green laser at the second position 10-2, not only Cy3B dye but also Cy5 dye emits. These optical signatures, which we refer to as optical barcode in this specification, can be used to distinguish between the target biochemical component 10 and other species which also may be present in the sample.

In some implementations, two or more target biochemical component 10 may be detected simultaneously using the optical barcode scheme.

For example, the viral ssRNA from SARS-CoV-2 and flu RNA can be targeted in the same solution. The detection probes DP can be designed such that existing 2× imaging probes IP with Cy5 dyes bind to the flu RNA. In addition, the 1× set of detection probes DP can be designed to bind to an imaging probe IP with Alexa488 dye. So for the flu RNA, the intensity ratio corresponds to blue:green:red=1:0:2 and no FRET is observed.

The target biochemical components 10 may arrive at the focal volume at different times. When the first target biochemical component 10 arrives in the focal volume, the blue laser may be on and when the second target biochemical component 10 arrives in the focal volume, the green laser may be on.

In some implementations, in order for the data analysis of the optical barcode information taking into the consideration of the fact that each target biochemical component 10 arrives at the focal volume at different times, the pixels in the stripe 350 may be shifted along the direction of the strip such that every strip 350 starts with the blue as the first area 350-1. For this purpose, the green laser, or the illumination light 142-1, 142-2 for the second position 10-2 and the second area 350-2 is maintained for a longer duration. For example, when the exposure time is 10 ms for a full frame, rather than dividing the frame into 3.33 ms of blue, 3.33 ms of green, 3.33 ms of red illuminations in each frame, the exposure time is divided into 2.5 ms of blue, 5 ms of green, 2.5 ms of red. FIG. 3b shows an example of the optical barcode data after shifting is completed.

In the example of FIG. 3b, the detector 150 is divided into two channels, a first channel 352-1 and a second channel 352-2. The first channel 352-1 is configured to receive the emission on excitation from 488 nm, blue, and 561 nm, green. The second channel 352-2 is for the emission on excitation from 640 nm, red.

Each of the three-sectioned intensity strips 353-1, 353-2 extending in y-direction corresponds to the emission 11-1, 11-2, 11-3 collected from the first to third positions 10-1, 10-2, 10-3 on the first the third area 350-1, 350-2, 350-3 on the detector 150. The optical barcode of each target biochemical component 10 includes two three-sectioned intensity strips 353-1, 353-2 in the first channel 352-1 and the second channel 352-2, respectively.

Therefore, when three colour excitations for three positions 10-1, 10-2, 10-3 and two channels 352-1, 352-2 of detection are considered, the optical barcode of each target biochemical component 10 six data points. The optical barcode scheme facilitates distinguishing false positives where these six data point values can be random. In order to use the full dimensions of the optical data in the two spectral channels 352-1, 352-2, it may be arranged such that there is FRET among the imaging probes IP and the labelling probes LP used in the measurement. If blue laser is on, in the left channel 352-1 the blue emission is detected, and in the right channel 352-2 any emission arising from FRET or any spectral crosstalk due to energy transfer from the blue fluorophore to the red fluorophore. If the green laser is on, in the left channel 352-1 the green emission is detected, and in the right channel any FRET or spectral crosstalk due to energy transfer from the blue fluorophore to the red fluorophore. If the red laser is on, in the right channel 352-2 the red emission is detected and there is no emission from FRET.

FIG. 4 is a schematic that illustrates a microfluidic chip for detecting biochemical component with references to FIG. 1.

A microfluidic chip 400 which includes one or more microfluidic channel 120 as explained in FIG. 1. The flow rate can be controlled with a flow sensor (not shown). The flow sensor can be part of the system that controls the flow rate going into the microfluidic chip 400. The microfluidic channel 120 can be 400 um×250 um in profile and up to 10 mm long. The dimensions 400 micron×250 micron of the channel in the vertical section 121 can match the illumination area at the focal plane of the imaging lens 130 of the optical detection system 100. Also, the imaging lens 130 can be chosen such that the area of 400 micron×250 micron can be imaged onto the detector 150 with minimum aberration.

The microfluidic chip 400 includes a plurality of wells or holes 411, 412, 413, 414, 415, which act as inlets or outlets to the path defined by the microfluidic channel 120.

A sample well 411 is an inlet for receiving the sample solution or the patient sample, for example nasal liquid or saliva of the patient.

A reaction buffer well 412 is an inlet for receiving a reaction buffer, for example, a solution containing Zn2+ and labelling probes LP.

The microfluidic channels 120 connected respectively to the sample well 411 and the reaction buffer well 412 merge into a single microfluidic channel 120, which leads to a fluidic mixer 420, where the patient sample and the reaction buffer are mixed.

The microfluidic channel 120 which acts as an output of the fluidic mixer 420 is connected to the observation section 121, where the mixture of the sample solution and the reaction buffer is optically interrogated and imaged by the optical detection system 100 described in FIG. 1. In the example of FIG. 4, the central axis 131, 331 and/or the flow direction 322 are in the negative z-direction such that the imaging lens 130 is placed looking into the xy-plane. The illumination source 140-2 is arranged such that the illumination light 141-2 is a light sheet directed in the negative x-direction. However, the configuration of the optical detection system 100 and the flow direction 332 are not limited to configuration described in the example of FIG. 4. The observation section 121 and the optical detection system 100 can be arranged as long as they are described in FIG. 1.

The output of the observation section 121 is connected to the microfluidics channel 120 forming a T-section, diverging into two paths of the microfluidics channel 120. One of the two paths is connected to a washing buffer well 415, which is an inlet to which a washing solution is introduced with positive pressure relative to atmosphere. The other of the two paths is connected to a fluidic sorter 430.

The microfluidic chip 400 can be a consumable, or it can also be reused by cleaning with washing buffer introduced into the washing buffer well 415 before each use.

The cleaning may be automated. In the example of FIG. 4, the microfluidic chip 400 includes two copies of each feature, with a mirror symmetry around the yz-plane. These two copies are referred to as “testing modules”, so in this case the microfluidic chip includes two testing modules. For example, the microfluidic chip 400 may include two of the sample wells 411. One patient sample can be introduced to one of the sample wells 411 while the other sample well 411 is being cleaned. While one side is cleaning, the other side can be imaged. A motorized stage can be used to move the chip to align the observation section 121 with the optical detection system 100.

The fluidic sorter 430 may be used to sort only viruses from the sample solution. After optically imaging the sample solution at the observation section 121, when viruses are detected, a fluidic sorter 430 can send volumes of the solutions where virus is present to a collection well 414. The rest of the sample solution can be sent to a waste well 413. Whether a specific volume of sample contains virus or not can be observed at 121 so that the same volume can be sorted at the fluidic sorter 430 due to the known flow rate and the laminar nature of the flow.

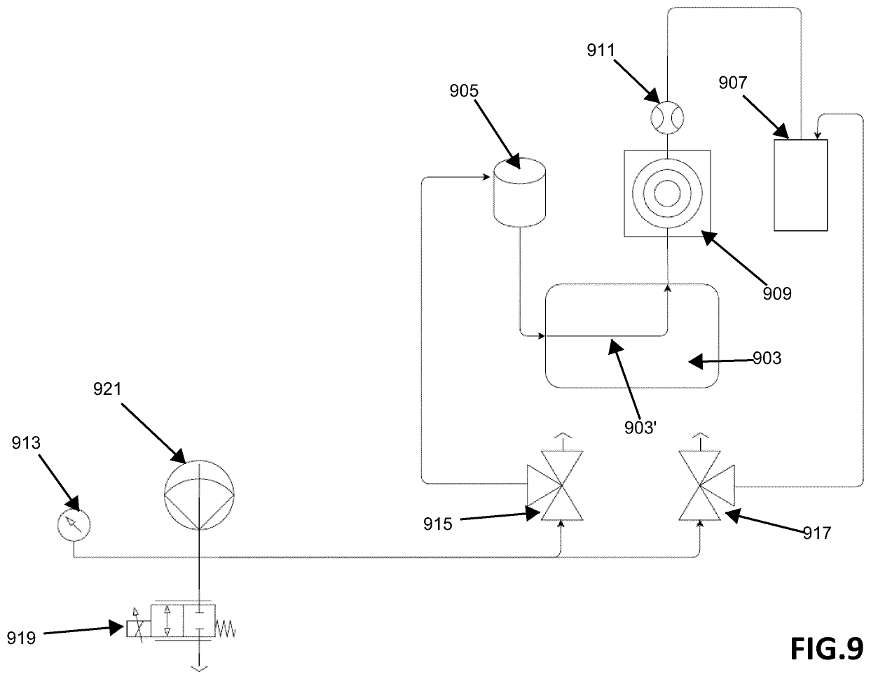

FIG. 9 shows a particularly advantageous delivery system 901 for driving liquid flow through the microfluidic chip. In this system, microfluidic chip 903 includes a microfluidic channel 903′ having an inlet line connected to sample holder 905, and an outlet line connected to wash bottle 907 via storage module 909 and flow sensor 911. In this case, the storage module is a coil of 0.5 to 1 metre of 0.3 mm inner diameter tubing. The diameter of the coil is comparable to that of the microfluidic channel, which simplifies connection to the microfluidic chip and can help to maintain laminar flow in the system. However, the skilled reader will understand that other types of storage module are possible.

The sample holder 905 and wash bottle 907 are connected to positive pressure source 913 via three-way valves 915 and 917 respectively, such that a circuit is formed between the two valves. One port on each of the three-way valves 915 and 917 serves as a vent to air. The pressure source is adjusted by proportional valve 919, and monitored by pressure sensor 921.

To initiate use of the microfluidic chip, the microfluidic chip is primed by connecting valve 917 to pressure source 913 and venting valve 915, thereby allowing pressure source 913 to pressurise wash bottle 907 and back-fill the storage module 909 and microfluidic channel 903′ with rinse fluid. This is continued until the rinse fluid reaches sample holder 905. To begin measurement of the sample, valve 915 is connected to pressure source 913 and valve 917 is vented to air, to allow the pressure source 913 to pressurise the sample holder 905, and thereby drive sample into the microfluidic channel 903′ and thence on to the storage module 909, displacing a portion of the rinse fluid back into wash bottle 907. Advantageously, flow sensor 911 is able to measure flow rate in the microfluidic channel 903′ based on the flow of displaced rinse fluid passing through it, without the need for the sample itself to contact the flow sensor. This limits the potential for contamination of the flow sensor and the wash bottle with sample.

This invention described herein allows a high-speed, high-throughput diagnosis test. For example, diagnosis test of SARS-CoV-2 with ssRNA as the target can be carried out within 13 minutes from sample collection to getting the test result, of which 10 minutes are incubation time for the hybridization of DPs to the target and at the same time IPs to the DPs to occur, and an on-instrument runtime of 0 minutes (in case of a positive sample) to 3 minutes (in case of a negative sample). The test output is the number of particles detected in the sample volume, the most quantitative measure conceivable. Only nucleic acids and other scalable biochemical components are required for the test, making it affordable and easy to scale. No proteins of any kind are required.

In order to find out whether the patient has any virus at all in their saliva or nasal fluid, for example, Zn2+ mediated specific labelling of viruses discussed above can be used. When positive particles are found during flow and imaging, the detected particles can concentrated in the collection well 414. The concentrated virus can be lysed and the nucleic acid genome can be made accessible. The hybridization based assay can then determine the identity of the virus, if such information is desired.

In many applications (e.g. at an airport, or at the entrance of an office building), it is important to find out whether someone has any enveloped virus in their saliva or nasal fluid. No swabs are required for collection of such samples making such tests painless and compatible with routine screening. A decision (fly or no fly, letting someone into work or not) can be made based on this result alone.

The embodiments of the invention shown in the drawings and described hereinbefore are exemplary embodiments only and are not intended to limit the scope of the invention, which is defined by the claims hereafter. It is intended that any combination of non-mutually exclusive features described herein are within the scope of the present invention.

1. A detection system, comprising:
a microfluidic channel configured to receive a sample solution containing a target biochemical component and configured to support a flow of the sample solution;
an imaging lens;
an excitation light source configured to emit an excitation light into a focal volume of the imaging lens; and
detection apparatus comprising a detector,
wherein the microfluidic channel comprises an observation section where the flow is aligned with respect to a central axis of the imaging lens such that the focal volume is within the observation section and the target biochemical component moves through a focal plane of the imaging lens during a movement along the observation section, and
wherein the detector is configured to detect a light signal emitted by the target biochemical component on excitation with the excitation light.

2. The detection system according to claim 1, wherein the microfluidic channel is configured to support flow parallel to the central axis such that an emission from the target biochemical component is received around a fixed point on the detector during the movement through the focal volume.

3. The detection system according to claim 1, wherein the detector is a camera.

4. The detection system according to claim 1, wherein the detection system is configured to detect the target biochemical component through fluorescence, or a combination of fluorescence and scattering.

5. The detection system according to claim 1, wherein the excitation light source is configured to provide excitation light comprising a plurality of wavelengths and the detection apparatus is configured to distinguish respective spectral channels of the light signals generated on excitation with the plurality of wavelengths of the excitation light source.

6. The detection system according to claim 1, wherein the excitation light source is configured to provide excitation light comprising one or more light sheets directed across the microfluidic channel.

7. The detection system according to claim 6, wherein the excitation light source is configured to provide the one or more light sheets laterally at and parallel to the focal plane of the imaging lens.

8. The detection system according to claim 6, wherein the excitation light source is configured to provide excitation light comprising one or more light sheets comprising a plurality of wavelengths.

9. The detection system according to claim 1, wherein the excitation light source comprises one or more fibre-coupled light sources, such as one or more fibre-coupled lasers.

10. The detection system according to claim 9, wherein the excitation light source comprises multiple fibre-coupled light sources configured to provide excitation light at different wavelengths, wherein the ends of the fibre-coupled light sources are arranged side-by-side in an array on one side of the microfluidic channel, and wherein a shared lens is positioned in front of the ends of the fibre-coupled light sources to shape the excitation light from the multiple fibre-coupled light sources into a light sheet during use.

11. The detection system according to claim 1, wherein the detection apparatus comprises one or more optical filters to separate light signals into two or more colour channels, wherein the different colour channels are detected on separate detectors and/or detected on separate areas of a single detector.

12. The detection system according to claim 1, wherein the detection apparatus comprises a dispersive element to separate light signals into different wavelengths such that different wavelengths illuminate different parts of the detector.

13. The detection system according to claim 1, wherein the microfluidic channel is configured to support flow parallel to the central axis of the imaging lens, the excitation light source is configured to provide excitation light comprising one or more light sheets comprising different wavelengths illuminated laterally at and parallel to the focal plane of the imaging lens, the detection apparatus comprises one or more optical filters to separate light signals into two or more colour channels, and the detection apparatus preferably further comprises a dispersive element to separate light signals into different wavelengths such that different wavelengths illuminate different parts of the detector(s).

14. The detection system according to claim 12, wherein the dispersive element is a prism.

15. The detection system according to claim 12, wherein the dispersive element is a doublet compound prism formed from two wedge prisms fused/cemented along a shared facet such that their apex angles face away from one another.

16. The detection system according to claim 12, wherein the microfluidic channel is provided as part of a testing module on a microfluidic chip, and the microfluidic chip comprises multiple such testing modules, wherein the microfluidic chip is movable so that the testing modules can be examined in turn.

17. The detection system according to claim 16, wherein the detection system includes a motor configured to move the microfluidic chip to allow testing modules to be examined in turn.

18. The detection system according to claim 16, wherein the system is housed in a lightproof housing.

19. A method of detecting a target biochemical component, the method comprising:
preparing a sample solution containing the target biochemical component such that the target biochemical component is labelled with one or more optical markers;
sending the sample solution into a microfluidic channel configured to support a flow of the sample solution;
providing an excitation light into focal volume of an imaging lens;
detecting the target biochemical component using a detector configured to detect a light signal emitted by the one or more optical markers on excitation with the excitation light,
wherein the microfluidic channel comprises an observation section where the flow is aligned with respect to a central axis of the imaging lens such that the focal volume is within the observation section and the target biochemical component moves through a focal plane of the imaging lens during a movement along the observation section.

20. A method according to claim 19, wherein detecting the target biochemical component using a detector comprises imaging the target biochemical component using a camera.

21. A method according to claim 19, wherein the optical markers are fluorescent markers, and the light signals are fluorescence emission.

22. A method according to claim 19, wherein providing an excitation light comprises providing excitation light comprising different wavelengths.

23. A method according to claim 19, wherein the different wavelengths are used to excite spectrally distinct optical markers.

24. A method according to claim 19, wherein providing an excitation light comprises providing one or more light sheets into the focal volume of the imaging lens, preferably across the microfluidic channel.

25. A method according to claim 24, wherein the one or more light sheets are illuminated laterally at and parallel to the focal plane of the imaging lens.

26. A method according to claim 24, wherein the one or more light sheets comprise different wavelengths.

27. A method according to claim 26, wherein said one or more light sheets are provided by multiple fibre-coupled light sources, each or a subset of the fibre-coupled light sources providing a different wavelength, wherein the ends of the fibre-coupled light sources are arranged side-by-side in an array on one side of the microfluidic channel so as to emit parallel beams which impinge on a shared lens which focuses the light sheets into the focal volume.

28. A method according to claim 19, comprising separating the light signals into two or more colour channels.

29. A method according to claim 19, wherein the microfluidic channel is provided as part of a testing module on a microfluidic chip, and the method involves imaging a first testing module whilst simultaneously cleaning a second testing module, before switching to imaging of the second testing module and cleaning of the first testing module.

30. A method according to claim 19, comprising:
preparing a sample solution containing the target biochemical component such that the target biochemical component is labelled with one or more fluorescent markers;
sending the sample solution into a microfluidic channel configured to support a flow of the sample solution, wherein the microfluidic channel comprises an observation section;
providing multiple excitation light sheets comprising different wavelengths into the focal volume of an imaging lens, wherein the multiple light sheets are illuminated laterally at and parallel to the focal plane of the imaging lens, and wherein the focal volume is within the observation section of the microfluidic channel and flow of the sample solution is parallel to the central axis of the imaging lens within the observation section;
imaging the target biochemical component using detection apparatus configured to detect fluorescence emission emitted by the one or more fluorescent markers on excitation with the excitation light sheets as the target biochemical component moves through a focal plane of the imaging lens during a movement along the observation section; wherein the detection apparatus comprises one or more optical filters to separate the fluorescence emission into two or more colour channels which are detected on separate cameras and/or detected on separate areas of a single camera, and optionally wherein the detection apparatus comprises a dispersive element to separate light signals into different wavelengths before it is detected by the camera(s).

31. A method according to claim 19, wherein the target biochemical component is a pathogen and the concentration of pathogen in the sample solution is chosen so that multiple pathogens are observed/observable in the focal volume simultaneously.

32. A method according to claim 19, wherein the method is used for detecting a pathogen in a sample of bodily fluid, and comprises the steps of:
obtaining a sample of bodily fluid from a patient;
incubating the sample with one or more fluorescent markers capable of binding to a pathogen of interest;
sending the sample solution into the microfluidic channel configured to support a flow of the sample solution, wherein the microfluidic channel comprises an observation section;
providing multiple excitation light sheets comprising different wavelengths into the focal volume of the imaging lens, wherein the multiple light sheets are illuminated laterally at and parallel to the focal plane of the imaging lens, and wherein the focal volume is within the observation section of the microfluidic channel and flow of the sample solution is parallel to the central axis of the imaging lens within the observation section;
imaging fluorescence emitted by the sample as it flows through the focal plane of the imaging lens using detection apparatus; the detection apparatus comprising one or more optical filters to separate the fluorescence emission into two or more colour channels which are detected on separate cameras and/or detected on separate areas of a single camera, and optionally wherein the detection apparatus comprises a dispersive element to separate light signals into different wavelengths before it is detected by the detector(s);
identifying fluorescent events above a threshold in the two or more colour channels; using the fluorescent events to identify whether pathogens are present in the sample.


SEQUENCE LISTING (2 sequences)

SEQ ID NO: 1 - DNA, 20 bp, Artificial Sequence
  Synthetic, Directly labelled detection probe
gcatgcagccgagtgacagc

SEQ ID NO: 2 - DNA, 20 bp, Artificial Sequence
  Synthetic, Quenching probe
gctgtcactcggctgcatgc